(19) United States
(12) Patent Application Publication
(10) Pub. No.: US 2013/0065174 A1
(43) Pub. Date: Mar. 14, 2013

(54) TONER

(71) Applicants: Hitoshi Itabashi, Yokohama-shi (JP); Takashi Kenmoku, Mishima-shi (JP); Akane Masumoto, Yokohama-shi (JP)

(72) Inventors: Hitoshi Itabashi, Yokohama-shi (JP); Takashi Kenmoku, Mishima-shi (JP); Akane Masumoto, Yokohama-shi (JP)

(73) Assignee: CANON KABUSHIKI KAISHA, Tokyo (JP)

(21) Appl. No.: 13/603,830

(22) Filed: Sep. 5, 2012

(30) Foreign Application Priority Data
Sep. 9, 2011 (JP) 2011-196801

(51) Int. Cl. G03G 9/08

(52) U.S. Cl. 430/108.3; 430/108.4

(57) ABSTRACT

An object of the present invention is to provide a toner in which a charging amount and rise of the charging amount are hardly influenced by change in a temperature and humidity environment, and pigment dispersibility is high in order to provide an image output having high transparency, color mixing properties, and color nuance stability. The present invention is a toner comprising toner particles each comprising a metallic compound and a colorant, wherein the metallic compound is a compound having a structure bonded to a metal in a site derived from —COOM¹ and/or —OH of a salicylic acid structural moiety or a salicylic acid derivative structural moiety of an aromatic compound represented by formula (1) below:

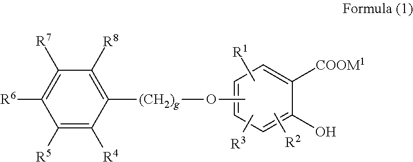

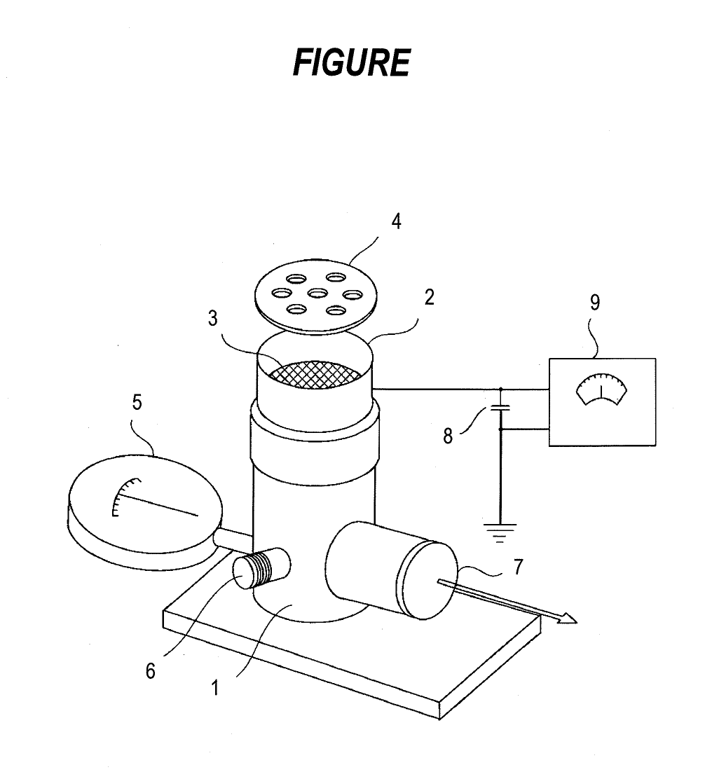

### BACKGROUND OF THE INVENTION

1. Field of the Invention

The present invention relates to a toner for developing an electrostatically charged image in an image forming method such as electrophotography and electrostatic printing, or relates to a toner for forming a toner image in a toner jet image forming method.

2. Description of the Related Art

Recently, in printers and copiers, there have been demands for higher speed, higher stability, and size reduction, and it has been desired to reduce the number of parts by giving higher functions to the parts. In order to obtain a stable image density and stability of color nuance in electrophotography, fixed development conditions always need to be satisfied in a development process. If a toner has an unstable charging amount, however, developing bias conditions or the like have to be set properly for each development process, for example, giving a large load to a system for controlling developability. This often leads to an increased size of the apparatus or increase in production cost. In order to reduce such a load, there has been a demand for improving stability of the charging amount of the toner, and particularly, charging stability against change in temperature and humidity.

A variety of proposals has been made in order to improve the environmental stability of the toner charging amount. Among these, control using a charge control agent has been mainstream, and a toner containing a calixarene compound, a toner using an iron-containing azo dye, and a toner using an organic boron compound have been proposed (for example, Japanese Patent Application Laid-Open No. 2010-107678, Japanese Patent Application Laid-Open No. 2010-181845, and Japanese Patent Application Laid-Open No. 2010-243693). Unfortunately, in the toners as above, unstableness of the toner charging amount caused by change in the temperature and humidity environment and the rise property of the toner are insufficiently improved. The image density during printing may be changed, and particularly under a high temperature and high humidity, deficits such as image fogging accompanied by uneven distribution of the charging amount may be produced. Further, in order to obtain color nuance stability of an image, color mixing properties of the toner are important, and particularly a highlight portion needs transparency of the toner. From the viewpoint of resistance to fading, the colorant used for the toner is mainly pigments having high fastness. A variety of techniques for dispersing a pigment in a toner has been proposed. In many cases, mainly, a polar resin is added. Specifically, a PES charge control agent obtained by polycondensation of a monomer containing sulfonic acid (salt) has been proposed (for example, Japanese Patent Application Laid-Open No. 2003-096170 and Japanese Patent Application Laid-Open No. 2003-215853). According to these descriptions, a charge controlling resin is a polyester. This improves compatibility with a polyester binder resin and dispersibility of the pigment. Unfortunately, in fact, the dispersibility of the pigment and the binder resin is not sufficiently improved only by changing the composition of the charge control agent.

### SUMMARY OF THE INVENTION

Accordingly, an object of the present invention is to provide a toner in which a charging amount and rise of the charging amount are hardly influenced by change in a temperature and humidity environment.

Another object of the present invention is to provide a toner having high pigment dispersibility in order to provide an image output having high transparency, color mixing properties, and color nuance stability.

The present invention is a toner comprising toner particles each comprising a metallic compound and a colorant, wherein the metallic compound is a compound having a structure bonded to a metal in a site derived from —COOM¹ and/or —OH of a salicylic acid structural moiety or a salicylic acid derivative structural moiety of an aromatic compound represented by formula (1):

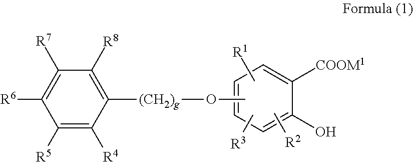

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; and M¹ represents a hydrogen atom, an alkali metal, NH₄, or a mixture thereof.

The present invention can provide a toner in which the charging amount and the rise property of the charging amount are hardly influenced by change in the temperature and humidity environment. Moreover, the toner can have high dispersibility of the pigment in the toner and high color nuance, and provide a highly fine output image.

Further features of the present invention will become apparent from the following description of exemplary embodiments with reference to the attached drawing.

### BRIEF DESCRIPTION OF THE DRAWINGS

FIGURE is a drawing illustrating a configuration of an apparatus used for measurement of the frictional charge amount of a developer using a toner according to the present invention.

### DESCRIPTION OF THE EMBODIMENTS

Preferred embodiments of the present invention will now be described in detail in accordance with the accompanying drawings.

The present inventors found out that if toner particles each contains a metallic compound according to the present invention, the effect of controlling a saturated charging amount in the related art is demonstrated, and additionally, dependency of the rise property of the charging amount on the temperature and humidity environment is reduced, and the dispersibility of the pigment in the toner can be improved. Thus, the present invention has been made.

Usually, frictionally charged charges produced on the surface of the toner are readily influenced by the absolute amount of moisture on the surface of the toner. The reason is thought as follows: water molecules greatly concern donation and reception of the charges, and if the water molecules are more frequently desorbed from the surface of the toner under a high humidity, the charge leakage rate is increased to reduce the saturated charging amount or a rising rate of the charging amount.

If the component having the structure described above exists in the toner particle, the charges produced by frictional charging are kept on the surface of the toner even under a high temperature and high humidity, and are difficult to influence by an external temperature and humidity.

The structure bonded to a metal in a site derived from —COOM¹ and/or —OH of the salicylic acid structural moiety or the salicylic acid derivative structural moiety contained in the component in the metallic compound according to the present invention has a structure resembling that of the charge control agent in the related art. Accordingly, it is thought that the structure bonded to a metal has an ability as a site in which the charges are produced by frictional charging. It is also thought that broadening of the conjugated system such as an oxygen atom and an aryl group existing within the component improves the rate of giving and receiving the charges to and from the binder resin or a charging member to enhance the charging rise property. An effect is also expected such that these structures allow the charges to be quickly discharged if excessive charging (overcharging) occurs, thereby preventing local overcharging.

An effect most expected in the present invention is that the produced charges are kept within the molecule by existence of the conjugated system broadening within the molecule, and are kept stable against change in the temperature and humidity, which is an external factor. Although the mechanism is not clear, it is thought that these phenomena are attributed to the metallic compound according to the present invention having a hydrophobic structure hardly influenced by the water molecule.

Meanwhile, the dispersibility of the pigment existing in the toner depends on wettability of the pigment and the binder resin. Accordingly, it can be thought that as a factor that the metallic compound according to the present invention demonstrates an effect of dispersing the pigment, the metallic compound adsorbs onto the surface of the pigment thereby to reform the surface of the pigment so as to be wettable to the binder resin. Although the mechanism of adsorption is not clear, a salicylic acid salt containing a metal or a metal complex component interacts with a polar group or a conjugated system existing on the surface of the pigment, thereby to promote the adsorption of the metallic compound. It is thought that a bulky molecule structure of the metallic compound according to the present invention adsorbed onto the pigment demonstrates an effect of suppressing aggregation of the pigments, leading to the effect of the present invention.

The present invention will be described in detail.

The metallic compound using in the toner according to the present invention is a compound having a structure bonded to a metal in a site derived from —OOM¹ and/or —OH of the salicylic acid structural moiety or the salicylic acid derivative structural moiety of an aromatic compound represented by formula (1):

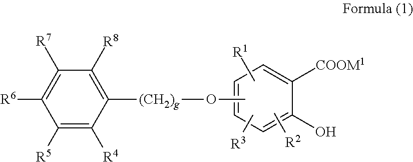

wherein R¹ to R³ each independently represent a hydrogen atom, a hydroxyl group, a carboxyl group, an alkyl group having not less than 1 and not more than 18 carbon atoms, or an alkoxy group having not less than 1 and not more than 18 carbon atoms;

R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms;

g represents an integer of not less than 1 and not more than 3; and

M¹ represents a hydrogen atom, an alkali metal, NH₄, or a mixture thereof.

The metallic compound according to the present invention can be obtained by reacting the aromatic compound represented by formula (1) (hereinafter, referred to as an “aromatic compound A”) with a metal reagent in water and/or an organic solvent (preferably, in an organic solvent). Usually, a reaction product in an organic solvent can be extracted by dispersing the reaction product in a proper amount of water, filtering the precipitate, washing the precipitate by water, and drying the precipitate. Although the specific structure of the metallic compound to be obtained is not clear, it is presumed that it is a metal salt compound or a metal complex having a structure bonded to a metal in a site derived from —COOM¹ and/or —OH of the salicylic acid structural moiety or the salicylic acid derivative structural moiety that the aromatic compound A has. —COOM¹ and/or —OH of the salicylic acid structural moiety or the salicylic acid derivative structural moiety refers to —COOM¹ and —OH of the following moiety represented by formula (B), which forms the right side in formula (1):

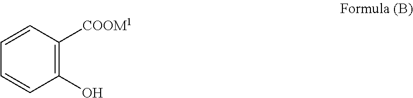

The reaction product of the aromatic compound A and the metal reagent can be obtained by reacting the aromatic compound A with the metal reagent in water and/or an organic solvent (preferably, in an organic solvent). Usually, the reaction product in an organic solvent can be extracted by dispersing the reaction product in a proper amount of water, filtering the precipitate, washing the precipitate by water, and drying the precipitate.

Examples of the organic solvent used for the reaction can include alcohol organic solvents, ether organic solvents, and glycol organic solvents such as methanol, ethanol, isopropanol, n-butanol, tert-butanol, ethylene glycol monomethyl ether, ethylene glycol monoethyl ether, ethylene glycol dimethyl ether (monoglyme), ethylene glycol diethyl ether, propylene glycol monomethyl ether, propylene glycol monoethyl ether, diethylene glycol dimethyl ether (diglyme), triethylene glycol dimethyl ether (triglyme), tetraethylene glycol dimethyl ether (tetraglyme), ethylene glycol, and propylene glycol; and water soluble organic solvents such as aprotic polar solvents such as tetrahydrofuran, N,N-dimethylformamide, N,N-dimethylacetamide, N-methyl-2-pyrrolidone, and dimethyl sulfoxide.

The amount of the organic solvent to be used is not particularly limited, and is the amount 2 to 50 times the amount of the aromatic compound as a mass ratio.

The metal reagent can be any metal reagent that can react with the salicylic acid or salicylic acid derivative moiety in the aromatic compound A to produce a metal and form a metallic compound. Examples of suitable metal reagents include zinc reagents (zincation reagents) such as zinc chloride, zinc sulfate, n-propoxyzinc, and n-butoxyzinc; calcium reagents (calcination reagents) such as calcium chloride and calcium hydrogen carbonate; magnesium reagents (magnesiation reagents) such as magnesium chloride, magnesium hydrogen carbonate, and magnesium carbonate; strontium reagents (strontiation reagents) such as strontium hydroxide and strontium nitrate; aluminum reagents (alumination reagents) such as aluminum chloride, aluminum sulfate, basic aluminum sulfate, aluminum acetate, basic aluminum acetate, aluminum nitrate, aluminum lactate, aluminum n-propoxide, aluminum isopropoxide, and t-butoxy aluminum; titanium reagents (titanation reagents) such as titanium chloride, titanium sulfate, n-propoxy titanium, isopropoxy titanium, and n-butoxy titanium; zirconium reagents (zirconation reagents) such as zirconium chloride, zirconium sulfate, n-propoxy zirconium, ethoxy zirconium, isopropoxy zirconium, and butoxy zirconium; chromium reagents (chromation reagents) such as chromium lactate, chromium formate, chromium sulfate, chromium chloride, and chromium nitrate; iron reagents (ironation reagents) such as ferric chloride, ferric sulfate, ferrous sulfate, ferric nitrate, and ferrous ferric chloride (Fe₃Cl₇.xH₂O, Fe₃Cl₈.xH₂O); boron reagent (boronation reagents) such as boric acid, boron trichloride, trimethoxyborane, and triethoxyborane; and silicon reagents (siliconization reagents) such as silicon tetrachloride, ethoxysilane, methoxysilane, butoxysilane, and isopropoxysilane. The amount of the metal reagent to be used is preferably not less than 0.02 and not more than 5.0 equivalents based on the aromatic compound A. More preferably, the amount is not less than 0.05 and not more than 3.0 equivalents based on the aromatic compound A.

Usually, the valence number of coordination and the coordination number in the metallic compound vary according to kinds of metals and ligands, and it is known that the central atom of the metal complex has the coordination number of approximately 2 to 12. For example, in the case where the central atom is aluminum, aluminum chloride and trialkylaluminum have a tetracoordinate structure, and tris(8-quinolinolato) aluminum has the coordination number of 6.

Hereinafter, presumed structural formulas of the metallic compound according to the present invention will be listed.

Namely, it is presumed that the metallic compound is represented by formula (2) below:

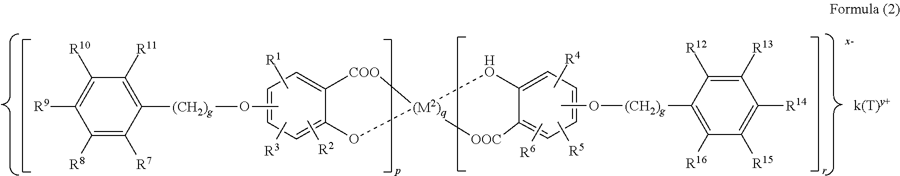

wherein R¹ to R⁶ each independently represent a hydrogen atom, a hydroxyl group, a carboxyl group, an alkyl group having not less than 1 and not more than 18 carbon atoms, or an alkoxy group having not less than 1 and not more than 18 carbon atoms; R⁷ to R¹⁶ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; M² represents Mg, Ca, Sr, Pb, Fe, Co, Ni, Zn, Cu, Al, B, Cr, Fe, Ni, Si, Zr, or Ti; p represents an integer of not less than 1 and not more than 6; r represents an integer of not less than 1 and not more than 6; q represents an integer of not less than 1 and not more than 4; k represents a number of not less than 0 and not more than 3; x represents an integer of not less than 0 and not more than 3; and y represents 1 or 2, and (T)^{y+} represents a cation. In the structural formula, the dotted line represents the case where M² is optionally coordinated with —OH. B (boron) is written as a metal.

Further, it is presumed that the metallic compound is represented by formula (3) below:

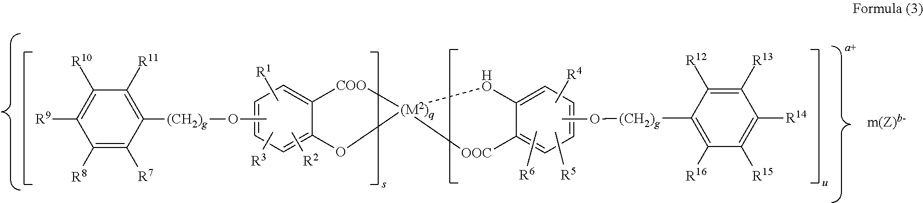

wherein R¹ to R⁶ each independently represent a hydrogen atom, a hydroxyl group, a carboxyl group, an alkyl group having not less than 1 and not more than 18 carbon atoms, or an alkoxy group having not less than 1 and not more than 18 carbon atoms; R⁷ to R¹⁶ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; M² represents Mg, Ca, Sr, Pb, Fe, Co, Ni, Zn, Cu, Al, B, Cr, Fe, Ni, Si, Zr, or Ti; s represents an integer of not less than 1 and not more than 6; u represents an integer of not less than 1 and not more than 6; t represents an integer of not less than 1 and not more than 4; a represents an integer of not less than 0 and not more than 3; b represents 1 or 2; and (Z)^{b-} represents an anion. Examples of anions as (Z)^{b-} include anions such as a hydroxide ion, a sulfate ion, a carbonate ion, a hydrogencarbonate ion, an acetate ion, a lactate ion, and halogen ions. In the structural formula, the dotted line represents the case where M² is optionally coordinated with —OH.

In formula (2) or formula (3), a case where M² is a metal M, and the metal M is divalent, trivalent, and tetravalent will be described.

In the case where the metal M is a trivalent metal (Al³⁺, B³⁺, Cr³⁺, Fe³⁺, or Ni³⁺), presumed structural formulas will be shown in formulas (4) to (12) below:

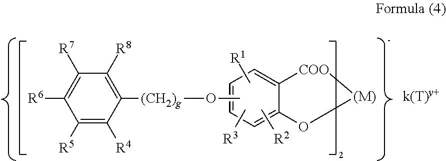

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; k represents 1 or 1/2; and y represents 1 or 2, (T)^{y+} represents a cation selected from a hydrogen atom, alkali metals, and alkaline earth metals, or an ammonium ion;

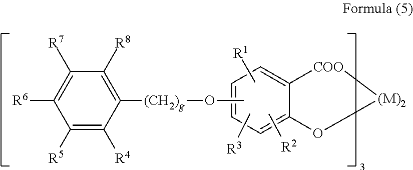

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; and g represents an integer of not less than 1 and not more than 3;

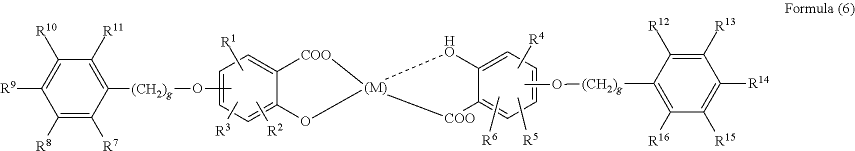

wherein R¹ to R⁶ each independently represent a hydrogen atom, a hydroxyl group, a carboxyl group, an alkyl group having not less than 1 and not more than 18 carbon atoms, or an alkoxy group having not less than 1 and not more than 18 carbon atoms; R⁷ to R¹⁶ each independently represent a hydrogen atom, a vinyl group, a hydroxyl group, an alkyl group having not less than 1 and not more than 18 carbon atoms, or an alkoxy group having not less than 1 and not more than 18 carbon atoms; and g represents an integer of not less than 1 and not more than 3. In the structural formula, the dotted line represents the case where M is optionally coordinated with —OH;

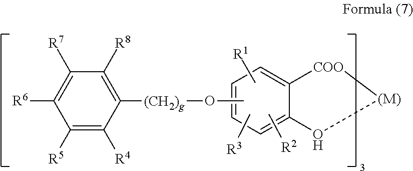

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; and g represents an integer of not less than 1 and not more than 3. In the structural formula, the dotted line represents the case where M is optionally coordinated with —OH;

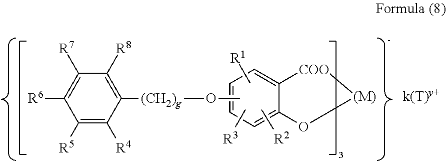

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; k represents 3 or 3/2; y represents 1 or 2; and (T)^{y+} represents a cation selected from a hydrogen atom, alkali metals, and alkaline earth metals, or an ammonium ion;

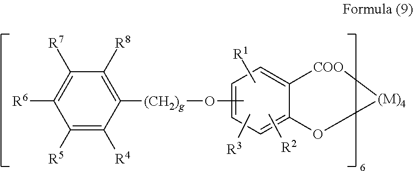

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; and g represents an integer of not less than 1 and not more than 3;

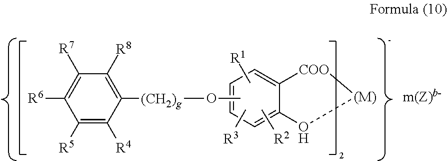

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; m represents 1 or 1/2, b represents 1 or 2; and (Z)^{b-} represents an anion selected from a hydroxide ion, a sulfate ion, a carbonate ion, a hydrogencarbonate ion, an acetate ion, a lactate ion, and halogen ions;

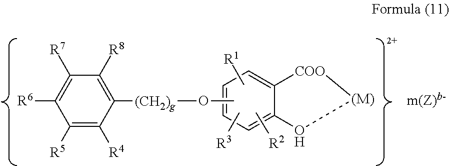

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; m represents 2 or 1, b represents 1 or 2, and (Z)^{b-} represents an anion selected from a hydroxide ion, a sulfate ion, a carbonate ion, a hydrogencarbonate ion, an acetate ion, a lactate ion, and halogen ions; and

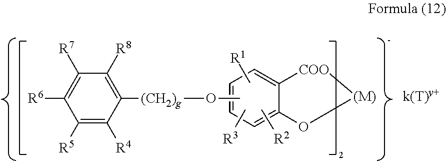

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; k represents 1 or 1/2; and y represents 1 or 2; (T)^{y+} is a compound of a trivalent metal and A shown below, and specifically represented by (M(A)ₙ)^{y+}, wherein A represents an anion selected from a hydroxide ion, a sulfate ion, a carbonate ion, a hydrogencarbonate ion, an acetate ion, a lactate ion, and halogen ions, and n is the number of A and represents 1 or 2.

In the case where the metal M is a divalent metal (Mg²⁺, Ca²⁺, Sr²⁺, Pb²⁺, Fe²⁺, Co²⁺, Ni²⁺, Zn²⁺, or Cu²⁺), presumed structural formulas will be shown in formulas (13) to (16).

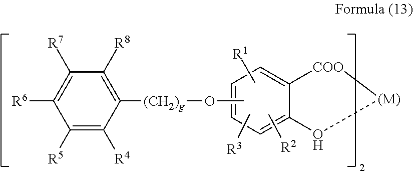

wherein R¹ to R³ each independently represent a hydrogen atom, a hydroxyl group, a carboxyl group, an alkyl group having not less than 1 and not more than 18 carbon atoms, or alkoxy group having not less than 1 and not more than 18 carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; and g represents an integer of not less than 1 and not more than 3;

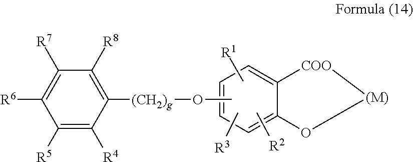

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; and g represents an integer of not less than 1 and not more than 3;

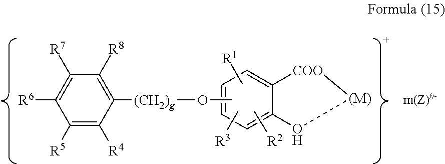

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; m represents 1 or 1/2; b represents 1 or 2; and (Z)^{b-} represents an anion selected from a hydroxide ion, a sulfate ion, a carbonate ion, a hydrogencarbonate ion, an acetate ion, a lactate ion, and halogen ions; and

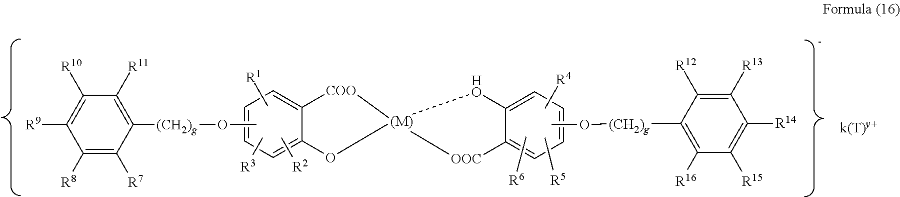

wherein R¹ to R⁶ each independently represent a hydrogen atom, a hydroxyl group, a carboxyl group, an alkyl group having not less than 1 and not more than 18 carbon atoms, or an alkoxy group having not less than 1 and not more than 18 carbon atoms; R⁷ to R¹⁶ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; k represents 1; y represents 1; and (T)^{y+} is a compound of a divalent metal and A shown below, specifically represented by (M(A)ₙ)^{y+}, wherein A represents an anion selected from a hydroxide ion, a sulfate ion, a carbonate ion, a hydrogencarbonate ion, an acetate ion, a lactate ion, and halogen ions, and n is the number of A and represents 1/2 or 1.

In the case where the metal M is a tetravalent metal (Si⁴⁺, Zr⁴⁺, or Ti⁴⁺), presumed structural formulas will be shown in formulas (17) and (18).

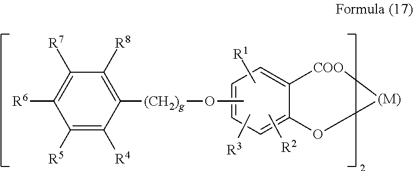

wherein R¹ to R³ each independently represent a hydrogen atom, a hydroxyl group, a carboxyl group, an alkyl group having not less than 1 and not more than 18 carbon atoms, or an alkoxy group having not less than 1 and not more than carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; and g represents an integer of not less than 1 and not more than 3; and

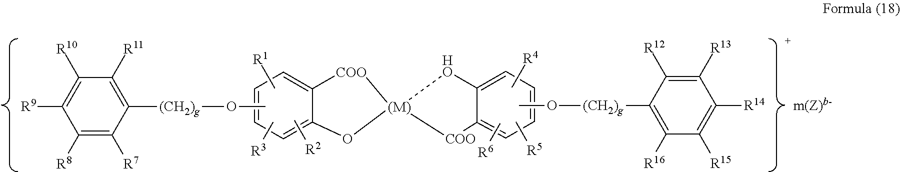

wherein R¹ to R⁶ each independently represent a hydrogen atom, a hydroxyl group, a carboxyl group, an alkyl group having not less than 1 and not more than 18 carbon atoms, or an alkoxy group having not less than 1 and not more than 18 carbon atoms; R⁷ to R¹⁶ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; m represents a number of 1 or 1/2; b represents 1 or 2; and (Z)^{b-} represents an anion selected from a hydroxide ion, a sulfate ion, a carbonate ion, a hydrogencarbonate ion, an acetate ion, a lactate ion, and halogen ions.

An aromatic compound represented by formula (1), which can be a ligand in the metallic compound according to the present invention, will be described.

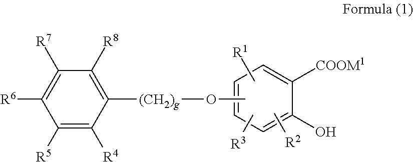

wherein R¹ to R³ each independently represent a hydrogen atom, a hydroxyl group, a carboxyl group, a carboxylic acid salt, an alkyl group having not less than 1 and not more than 18 carbon atoms, or an alkoxy group having not less than 1 and not more than 18 carbon atoms; R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms; g represents an integer of not less than 1 and not more than 3; M¹ represents a hydrogen atom, an alkali metal, NH₄, or a mixture thereof.

Examples of the carboxylic acid salts substitutable for the substituents R¹ to R³ can include alkali metal salts such as COONa and COOK, and COONH₄ or a mixture thereof.

Examples of the alkyl group having not less than 1 and not more than 18 carbon atoms substitutable for the substituents R¹ to R⁸ can include a methyl group, an ethyl group, a propyl group, an isopropyl group, an n-butyl group, a tert-butyl group, an n-pentyl group, an isopentyl group, a hexyl group, a heptyl group, and an octyl group.

Examples of the alkoxy group having not less than 1 and not more than 18 carbon atoms substitutable for the substituents R¹ to R⁸ can include a methoxy group, an ethoxy group, an n-propoxy group, an isopropoxy group, an n-butoxy group, an isobutoxy group, a tert-butoxy group, an n-pentoxy group, an isopentoxy group, a hexyloxy group, a heptoxy group, an oxyoctyl group, and an oxy-2-ethylhexyl group.

g represents an integer of 1 to 3. Preferably, g is 1, and the effect of the present invention can be demonstrated in this case. Although details are not clear, when g is 0, the benzene ring having the salicylic acid structure and a benzene ring to be bonded to the benzene ring having the salicylic acid structure are bonded only by an oxygen atom. While this structure has the broadening of the conjugated system, the motion of the benzene ring is limited. For this reason, it is thought that the effect is difficult to demonstrate in donation and reception of charges by interaction with the resin that exists therearound.

Meanwhile, when g is not less than 4, the distance between the two benzene rings is large, and donation and reception of charges are difficult to occur. For this reason, it is thought that the effect of the broadening of the conjugated system is reduced.

M¹ represents a hydrogen atom, an alkali metal (such as Li, Na, and K), NH₄, or a mixture thereof.

The aromatic compound A in the present invention can be synthesized using a known method such as the Williamson reaction described in Jikken Kagaku Koza, the 4th edition, p. 187. As an example, the aromatic compound A can be synthesized by reacting a phenyl alkylene halide optionally having a substituent with hydroxysalicylic acid optionally having a substituent.

Specific examples of vinylphenyl alkylene halide optionally having a substituent include: 4-(chloromethyl)styrene, 4-(bromomethyl)styrene, 3-methoxy-4-(chloromethyl)styrene, 3-methoxy-4-(bromomethyl)styrene, 2-hydroxy-4-(chloromethyl)styrene, 2-hydroxy-4-(bromomethyl)styrene, 2-methoxy-4-(chloromethyl)styrene, 2-methoxy-4-(bromomethyl)styrene, 3-tert-butyl-4-(chloromethyl)styrene, 3-tert-butyl-4-(bromomethyl)styrene, 3-isooctyl-4-(chloromethyl)styrene, 3-isopropyl-4-(chloromethyl)styrene, 3-methyl-4-(chloromethyl)styrene, 3-ethoxy-4-(chloromethyl)styrene, 3-carboxy-4-(chloromethyl)styrene, 3-(chloromethyl)styrene, 5-methyl-3-(chloromethyl)styrene, 5-isopropyl-3-(chloromethyl)styrene, 5-isooctyl-3-(chloromethyl)styrene, 5-methoxy-3-(chloromethyl)styrene, 4-ethoxy-3-(chloromethyl)styrene, 4-carboxy-3-(chloromethyl)styrene, 5-hydroxy-3-(chloromethyl)styrene, 4-hydroxy-3-(chloromethyl)styrene, 4-methoxy-3-(chloromethyl)styrene, 5-tert-butyl-3-(chloromethyl)styrene, 2-(chloromethyl)styrene, 3-tert-butyl-2-(chloromethyl)styrene, 4-(2-chloroethyl)styrene, 3-methoxy-4-(2-bromoethyl)styrene, 2-hydroxy-4-(2-chloroethyl)styrene, 3-ethoxy-4-(2-chloroethyl)styrene, 3-(2-chloroethyl)styrene, 5-isopropyl-3-(2-chloroethyl)styrene, 5-hydroxy-3-(2-chloroethyl)styrene, 4-hydroxy-3-(2-chloroethyl)styrene, 2-(2-chloroethyl)styrene, 4-(3-chloropropyl)styrene, 2-methoxy-4-(3-chloropropyl)styrene, 2-isopropyl-4-(3-chloropropyl)styrene, 2-isooctyl-4-(3-chloropropyl)styrene, 3-methoxy-4-(3-chloropropyl)styrene, 3-(3-chloropropyl)styrene, 5-isooctyl-3-(3-chloropropyl)styrene, 5-methoxy-3-(3-chloropropyl)styrene, and 2-(3-chloropropyl)styrene.

Specific examples of the hydroxysalicylic acid include hydroxysalicylic acids such as 2,3-dihydroxybenzoic acid, 5-methyl-2,3-dihydroxybenzoic acid, 5-ethyl-2,3-dihydroxybenzoic acid, 5-isopropyl-2,3-dihydroxybenzoic acid, 5-n-butyl-2,3-dihydroxybenzoic acid, 5-tert-butyl-2,3-dihydroxybenzoic acid, 5-isooctyl-2,3-dihydroxybenzoic acid, 4-carboxy-2,3-dihydroxybenzoic acid, 4-methoxy-2,3-dihydroxybenzoic acid, 4-ethoxy-2,3-dihydroxybenzoic acid, 6-butoxy-2,3-dihydroxybenzoic acid, 4-hydroxy-2,3-dihydroxybenzoic acid, 6-hydroxy-2,3-dihydroxybenzoic acid, 2,4-dihydroxybenzoic acid, 6-methyl-2,4-dihydroxybenzoic acid, 6-isopropyl-2,4-dihydroxybenzoic acid, 6-tert-butyl-2,4-dihydroxybenzoic acid, 6-isooctyl-2,4-dihydroxybenzoic acid, 5-methoxy-2,4-dihydroxybenzoic acid, 5-ethoxy-2,4-dihydroxybenzoic acid, 6-butoxy-2,4-dihydroxybenzoic acid, 6-carboxy-2,4-dihydroxybenzoic acid, 5-hydroxy-6-methyl-2,4-dihydroxybenzoic acid, 2,5-dihydroxybenzoic acid, 3-methyl-2,5-dihydroxybenzoic acid, 3-isopropyl-2,5-dihydroxybenzoic acid, 3-tert-butyl-2,5-dihydroxybenzoic acid, 3-isooctyl-2,5-dihydroxybenzoic acid, 3-carboxy-2,5-dihydroxybenzoic acid, 6-methoxy-2,5-dihydroxybenzoic acid, 3-tert-butoxy-2,5-dihydroxybenzoic acid, 6-hydroxy-3-methyl-2,5-dihydroxybenzoic acid, 3,4,6-isopropyl-2,5-dihydroxybenzoic acid, 2,6-dihydroxybenzoic acid, 3-isopropyl-2,6-dihydroxybenzoic acid, 4-tert-butyl-2,6-dihydroxybenzoic acid, and 5-methyl-2,6-dihydroxybenzoic acid.

Specific examples of the reaction solvent usable in the reaction include organic solvents such as alcohol, ether, and glycol organic solvents such as methanol, ethanol, ethylene glycol monomethyl ether, ethylene glycol monoethyl ether, propylene glycol monomethyl ether, ethylene glycol dimethyl ether, diethylene glycol dimethyl ether, ethylene glycol diethyl ether, triethylene glycol dimethyl ether, tetraethylene glycol dimethyl ether, ethylene glycol, and propylene glycol; aprotic polar solvents such as N,N-dimethylformamide, N,N-dimethylacetamide, N-methyl-2-pyrrolidone, and dimethyl sulfoxide; ketones such as acetone, methyl ethyl ketone, and methyl isobutyl ketone; esters such as ethyl acetate, butyl acetate, ethyl propionate, and cellosolve acetate; hydrocarbons such as hexane, octane, petroleum ether, cyclohexane, benzene, toluene, and xylene; and halogenated hydrocarbons such as trichloroethylene, dichloromethane, and chloroform. Preferably, in the reaction, a base is added in order to promote the reaction and capture hydrogen halides produced as a byproduct in formation of ether bonds. The base usable at this time is not particularly limited as long as the base does not make the reaction system complicated by reacting with the solvent or the medium. Examples of the base include hydroxides of alkali metals such as lithium hydroxide, sodium hydroxide, and potassium hydroxide; and carbonates of alkali metals such as lithium carbonate, sodium carbonate, and potassium carbonate.

The toner containing the metallic compound according to the present invention can be produced by various methods for producing a toner. Examples of the methods include: a kneading pulverization method in which the metallic compound is mixed with a binder resin, a pigment, and a mold release agent, the mixture is kneaded, and the kneaded product is crushed and classified to obtain toner particles; a suspension polymerization method in which the metallic compound is mixed with a polymerizable monomer, a pigment, and a mold release agent, the mixture is dispersed or dissolved and granulated in a water-based medium, and a polymerization reaction is performed to obtain toner particles; a dissolution suspension method in which the metallic compound, a binder resin, a pigment, and a mold release agent are dissolved or dispersed and mixed in an organic solvent, and granulated in a water-based medium, and the solvent is removed to obtain toner particles; and an emulsion agglomeration method in which the metallic compound, a binder resin, a pigment, and a mold release agent are finely dispersed in a water-based medium, and are agglomerated to have a toner particle diameter, thereby to obtain toner particles.

In the present invention, the amount of the metal derived from the metallic compound and contained in the toner is preferably not less than 1.0 μmol and not more than 100 μmol per g of the toner. At an amount of the metal within the range, an ability to hold the charges within the toner is enhanced. Additionally, the metal adsorbs to the pigment, and can suppress aggregation of the toner well. At an amount of the metal within the range, stability of the charging amount against temperature and humidity is particularly high. Moreover, a proper saturated charging amount can be kept to suppress aggregation of the toner particles well. In the toner according to the present invention, the content can be controlled by adjusting the amount of the components to be prepared in production of the toner.

In the present invention, the aromatic compound A does not need to be completely bonded to the metal, and may include a non-reacted compound. The non-reacted aromatic compound A demonstrates a charge leaking (dissipating) action. For this reason, the balance between the charging rate and the leakage rate changes according to the ratio of the non-reacted aromatic compound A to the metallic compound. In the case where the reaction rate is low and the ratio of the metallic compound existing is low, the leakage rate may be dominant, leading to slow rise of charging or reduction in the saturated charging amount.

The binder resin usable for the toner according to the present invention is not particularly limited, and examples thereof can include known resins. Specifically, examples of the binder resin can include styrene acrylic resins, polyester resins, polyether resins, polyamide resins, and hybrid resins obtained by combining these. A vinyl polymer unit in the vinyl resins and the hybrid resins may have a crosslinking structure in which monomers are crosslinked using a crosslinking agent having two or more vinyl groups.

The polymerizable monomer usable in production of the toner by the suspension polymerization method is not particularly limited, and known polymerizable monomers can be used. Specifically, examples thereof can include: styrenes such as styrene, o-methylstyrene, m-methylstyrene, p-methylstyrene, α-methylstyrene and derivatives thereof; ethylene unsaturated monoolefins such as ethylene, propylene, butylene, and isobutylene; halogenated vinyls such as vinyl chloride, vinylidene chloride, vinyl bromide, and vinyl fluoride; vinyl ester acids such as vinyl acetate, vinyl propionate, and vinyl benzoate; acrylic acid esters such as n-butyl acrylate and 2-ethylhexyl acrylate; methacrylic acid esters in which acrylate in the acrylic acid esters is replaced by methacrylate; methacrylic acid aminoesters such as dimethylaminoethyl methacrylate and diethylaminoethyl methacrylate; vinyl ethers such as vinyl methyl ether and vinyl ethyl ether; vinyl ketones such as vinyl methyl ketone; N-vinyl compounds such as N-vinyl pyrrole; vinylnaphthalenes; and acrylic acid or methacrylic acid derivatives such as acrylonitrile, methacrylonitrile, and acrylamide. The vinyl monomers may be used in combination with two or more thereof when necessary.

As a component to be copolymerized with the polymerizable monomer, a polymerizable monomer having a polar group can be used in combination. Specifically, examples thereof include: α,β-unsaturated acids such as acrylic acid, methacrylic acid, crotonic acid, and cinnamic acid; α,β-unsaturated acid anhydrides and anhydrides of α,β-unsaturated acids and lower fatty acids such as crotonic acid anhydride and cinnamic acid anhydride; and monomers having a carboxyl group such as alkenyl malonic acid, alkenyl glutaric acid, alkenyl adipic acid, acid anhydrides thereof, and monoesters thereof; acrylic acid or methacrylic acid esters such as 2-hydroxyethyl acrylate, 2-hydroxyethyl methacrylate, and 2-hydroxypropyl methacrylate; monomers having a hydroxyl group such as 4-(1-hydroxy-1-methylbutyl)styrene and 4-(1-hydroxy-1-methylhexyl)styrene; unsaturated dibasic acids such as maleic acid, citraconic acid, itaconic acid, alkenyl succinic acid, fumaric acid, and mesaconic acid; unsaturated dibasic acid anhydrides such as maleic anhydride, citraconic anhydride, itaconic anhydride, and alkenyl succinic anhydride; and half esters of unsaturated dibasic acids such as maleic acid methyl half ester, maleic acid ethyl half ester, maleic acid butyl half ester, citraconic acid methyl half ester, citraconic acid ethyl half ester, citraconic acid butyl half ester, itaconic acid methyl half ester, alkenyl succinic acid methyl half ester, fumaric acid methyl half ester, and mesaconic acid methyl half ester; and monomers having an unsaturated sulfonic acid such as para-styrene sulfonate.

The polymerization initiator usable in production of a styrene acrylic resin is not particularly limited, and known peroxide polymerization initiators and azo polymerization initiators can be used. Examples of organic peroxide polymerization initiators include peroxyesters, peroxydicarbonates, dialkyl peroxides, peroxyketals, ketone peroxides, hydroperoxides, and diacyl peroxides. Examples of inorganic peroxide polymerization initiators include peroxy esters such as t-butyl peroxyacetate, t-butyl peroxypivalate, t-butyl peroxyisobutyrate, t-hexyl peroxyacetate, t-hexyl peroxypivalate, t-hexylperoxy isobutyrate, t-butyl peroxyisopropyl monocarbonate, and t-butylperoxy 2-ethylhexyl monocarbonate; diacyl peroxides such as benzoyl peroxide; peroxydicarbonates such as diisopropyl peroxydicarbonate; peroxyketals such as 1,1-di-t-hexylperoxy cyclohexane; dialkyl peroxides such as di-t-butyl peroxide; and t-butylperoxy allyl monocarbonate. Examples of azo polymerization initiators include 2,2′-azo-bis-(2,4-dimethylvaleronitrile), 2,2′-azo-bisisobutyronitrile, 1,1′-azo-bis(cyclohexane-1-carbonitrile), 2,2′-azo-bis-4-methoxy-2,4-dimethylvaleronitrile, azo-bisisobutyronitrile, and dimethyl-2,2′-azo-bis(2-methylpropionate).

In the present invention, in the case where the binder resin is a polyester resin, the polyester resin is produced by polycondensing a polyhydric alcohol component and a polyvalent carboxylic acid component.

Examples of the polyhydric alcohol component that forms the polyester resin include the followings. Specifically, examples of dihydric alcohol components include alkylene oxide adducts of bisphenol A such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane; ethylene glycol, diethylene glycol, triethylene glycol, 1,2-propylene glycol, 1,3-propylene glycol, 1,4-butane diol, neopentyl glycol, 1,4-butene diol, 1,5-pentane diol, 1,6-hexane diol, 1,4-cyclohexane dimethanol, dipropylene glycol, polyethylene glycol, polypropylene glycol, polytetramethylene glycol, bisphenol A, and hydrogenated bisphenol A.

Examples of alcohol components having a valence of 3 or more include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Examples of the polyvalent carboxylic acid components include aromatic dicarboxylic acids such as phthalic acid, isophthalic acid, and terephthalic acid or anhydrides thereof; alkyl dicarboxylic acids such as succinic acid, adipic acid, sebacic acid, and azelaic acid or anhydrides thereof; succinic acid replaced by an alkyl group having 6 to 12 carbon atoms or anhydrides thereof; and unsaturated dicarboxylic acids such as fumaric acid, maleic acid, and citraconic acid or anhydrides thereof.

Among these, particularly preferably, a bisphenol derivative is used as the diol component, a carboxylic acid component comprising a carboxylic acid having a valence of or more, an acid anhydride thereof, or a lower alkyl ester thereof (such as fumaric acid, maleic acid, maleic anhydride, phthalic acid, terephthalic acid, trimellitic acid, and pyromellitic acid) is used as the acid component, and the polyester resin obtained by condensation polymerization of these can be preferably used.

In the present invention, the binder resin may be a hybrid resin having a polyester structure and modified with a vinyl monomer. A known method can be used as a method for hybridizing a polyester resin with a vinyl monomer. Specifically, examples of the method include a method in which a polyester is vinyl modified using a peroxide initiator to produce a hybrid resin, and a method in which a polyester resin having an unsaturated group is graft modified to produce a hybrid resin.

As a colorant that readily demonstrates an effect in the toner according to the present invention, colorants having a polar group and pigments having a large conjugated system such as aromatic derivatives are effective, and examples thereof can include various known colorants.

Examples of coloring pigments for magenta can include: naphthol pigments such as C.I. Pigment Red 3; naphthol AS pigments such as C.I. Pigment Reds 5, 17, 22, 112, and 146; pyrazolone disazo pigments such as C.I. Pigment Reds 38 and 41; quinacridone pigments such as C.I. Pigment Reds 122 and 202, C.I. Pigment Violet 19; perylene pigments such as C.I. Pigment Reds 123, 149, 178, 179, and 190; and dioxazine pigments such as C.I. Pigment Violet 23. These pigments may be used alone, or may be used in combination with a dye and a pigment.

Examples of coloring pigments for cyan include C.I. Pigment Blues 15, 15:1 and 15:3 or copper phthalocyanine pigments having a phthalocyanine skeleton substituted by one to five phthalimidomethyl groups.

Examples of coloring pigments for yellow can include: monoazo pigments such as C.I. Pigment Yellows 1, 3, 74, 97, and 98; disazo pigments such as C.I. Pigment Yellows 12, 13, 14, 17, 55, 83, and 155; condensation azo pigments such as C.I. Pigment Yellows 93, 94, 95, and 166; isoindolinone pigments such as C.I. Pigment Yellows 109 and 110; benzimidazolone pigments such as C.I. Pigment Yellows 154 and 180; and isoindoline pigments such as C.I. Pigment Yellow 185.

As a black colorant, those prepared to have a color of black using carbon black, aniline black, acetylene black, titanium black, and yellow/magenta/cyan colorants shown above can be used.

The toner according to the present invention can also be used as a magnetic toner. In this case, a magnetic body shown below is used. Examples of the magnetic body include iron oxides such as magnetite, maghemite, and ferrite, or iron oxides containing other metal oxide; metals such as Fe, Co, and Ni, alloys of these metals and a metal such as Al, Co, Cu, Pb, Mg, Ni, Sn, Zn, Sb, Ca, Mn, Se, and Ti, and a mixture thereof; and triiron tetraoxide (Fe₃O₄), diiron trioxide (γ-Fe₂O₃), zinc iron oxide (ZnFe₂O₄), copper iron oxide (CuFe₂O₄), neodymium iron oxide (NdFe₂O₃), barium iron oxide (BaFe₁₂O₁₉), magnesium iron oxide (MgFe₂O₄), and manganese iron oxide (MnFe₂O₄). The magnetic materials are used alone, or two or more thereof are used in combination. A particularly suitable magnetic material is fine particles of triiron tetraoxide or γ-diiron trioxide.

These magnetic bodies have an average particle diameter of preferably not less than 0.1 μm and not more than 2 μm, and more preferably not less than 0.1 μm and not more than 0.3 μm. In the magnetic properties at 795.8 kA/m (10 KOe), the coercivity (Hc) is not less than 1.6 kA/m and not more than 12 kA/m (not less than 20 Oe and not more than 150 Oe), and the saturation magnetization (δs) is not less than 5 μm²/kg and not more than 200 μm²/kg, and preferably not less than 50 μm²/kg and not more than 100 μm²/kg. The residual magnetization (δr) is preferably not less than 2 μm²/kg and not more than 20 μm²/kg. The amount of the magnetic body to be used is not less than 10 parts by mass and not more than 200 parts by mass, and preferably not less than 20 parts by mass and not more than 150 parts by mass based on 100 parts by mass of the binder resin.

The toner according to the present invention may contain a mold release agent. Examples of the mold release agent include aliphatic hydrocarbon waxes such as low molecular weight polyethylenes, low molecular weight polypropylenes, microcrystalline wax, and paraffin wax; oxides of aliphatic hydrocarbon waxes such as oxidized polyethylene wax; block copolymers of aliphatic hydrocarbon waxes; waxes containing a fatty acid ester as a main component such as carnauba wax, Sasol wax, and montanic acid ester wax; partially or totally deacidified fatty acid esters such as deacidified carnauba wax; partially esterified products of fatty acids and polyhydric alcohols such as behenic acid monoglyceride; and methyl ester compounds having a hydroxyl group and obtained by hydrogenating vegetable oils and fats. In molecular weight distribution of the mold release agent, the main peak is in the range of the molecular weight of preferably not less than 400 and not more than 2400, and more preferably not less than 430 and not more than 2000. Thereby, preferred thermal properties can be given to the toner. The total amount of the mold release agent to be added is preferably not less than 2.5 parts by mass and not more than 40.0 parts by mass, and more preferably not less than 3.0 parts by mass and not more than 15.0 parts by mass based on 100 parts by mass of the binder resin.

The toner particles according to the present invention are sufficiently mixed with a fluidity improver by a mixer such as a Henschel mixer. Thereby, a toner having the fluidity improver on the surface of the toner particle can be obtained. Examples of the fluidity improver include fluorine-containing resin powders such as vinylidene fluoride fine particles, polytetrafluoroethylene fine particles; silica fine particles such as silica fine particles produced by a wet method and silica fine particles produced by a dry method, and processed silica fine particles obtained by surface treating these silica fine particles with a treatment agent such as a silane coupling agent, a titanium coupling agent, and silicone oil; titanium oxide fine particles; alumina fine particles, processed titanium oxide fine particles, and processed alumina oxide fine particles. The fluidity improver provides good results when the specific surface area thereof measured by a BET method using nitrogen adsorption is not less than 30 m²/g, and preferably not less than 50 m²/g. The amount of the fluidity improver to be used may be not less than 0.01 parts by mass and not more than 8.0 parts by mass, and preferably not less than 0.1 parts by mass and not more than 4.0 parts by mass based on 100 parts by mass of the toner particle.

The weight average particle diameter (D4) of the toner may be not less than 3.0 μm and not more than 15.0 μm, and preferably not less than 4.0 μm and not more than 12.0 μm.

Moreover, the toner according to the present invention can be mixed with a magnetic carrier, and used as a two-component developer. As the magnetic carrier, metal particles of surface-oxidized or non-oxidized iron, lithium, calcium, magnesium, nickel, copper, zinc, cobalt, manganese, chromium, rare earth elements, particles of alloys thereof, particles of oxides thereof, and ferrite fine particles can be used.

In the development method in which an AC bias is applied to a developing sleeve, a coated carrier produced by coating the surface of the magnetic carrier core with a resin is preferably used. As the coating method, the followings are used: a method in which a coating material such as a resin is dissolved or suspended in a solvent to prepare a coating solution, and the coating solution is applied to the surface of the magnetic carrier core; and a method in which the magnetic carrier core is mixed with a coating material in a form of powder.

Examples of the coating material for the magnetic carrier core include silicone resins, polyester resins, styrene resins, acrylic resins, polyamides, polyvinyl butyral, and aminoacrylate resins. These are used alone, or two or more thereof are used. The amount of the coating material to be used for the treatment is not less than 0.1% by mass and not more than 30% by mass (preferably, not less than 0.5% by mass and not more than 20% by mass) based on the amount of the carrier core particle. As the average particle diameter of the magnetic carrier, the volume-based 50% particle diameter (D50) is preferably not less than 10 μm and not more than 100 μm, and more preferably not less than 20 μm and not more than 70 μm. In the case where a two-component developer is prepared, good results are obtained when the concentration of the toner in the developer is not less than 2% by mass and not more than 15% by mass, and preferably not less than 4% by mass and not more than 13% by mass as the mixing ratio of the magnetic carrier.

Hereinafter, measurement methods used in the present invention will be described.

<Determination of Content of Metal in Metallic Compound>

The amount of the metal in the metallic compound according to the present invention is determined by a fluorescent X-ray analyzer. The measurement method is according to JIS K 0119-1969, and specifically is performed as follows.

A wavelength dispersive fluorescent X-ray analyzer “Axios” (made by PANalytical B.V.) is used as the measurement apparatus, and an attached dedicated software “SuperQ ver. 4.0F” for setting the measurement conditions and analyzing the measurement data (made by PANalytical B.V.) is used. Rh is used for the anode in the X-ray tube. The measurement atmosphere is in vacuum, the measurement diameter (collimator mask diameter) is 27 mm, and the measurement time is 10 seconds. Detection is performed using a proportional counter (PC) when a light element is measured, and using a scintillation counter (SC) when a heavy element is measured.

A sample for measurement to be used is a pellet produced as follows: 4 g of a polymer is placed in a dedicated aluminum ring for press and made even; using a tablet molding press machine “BRE-32” (made by Maekawa Testing Machine Mfg. Co., LTD.), pressure is applied to the polymer at 20 MPa for 60 seconds to mold the polymer into a pellet having a thickness of 2 mm and a diameter of 39 mm.

Measurement is performed under the conditions above. From the obtained peak position of the X-ray, the element is identified. The concentration of the element is calculated from the counting rate (unit: cps), which is the number of X-ray photons per unit time.

The amount of the metal element is determined using the measurement result and a calibration curve created in advance for the metal element that undergoes determination.

<Measurement of Content of Metal in Toner>

The content of the metal in the toner is determined by an inductively coupled plasma atomic emission spectrometer (ICP-AES (made by Seiko Instruments Inc.)). As a pre-treatment, 200.0 mg of a sample is subjected to acid decomposition using 8.00 ml of nitric acid. Subsequently, ultrapure water is added such that the total amount is 50.00 g, and the obtained solution is used as the sample for measurement. A calibration curve is created from 6 points of 0, 0.50, 1.00, 5.00, 10.00, and 20.00 ppm, and the content of metal contained in the sample is determined. The solution obtained by adding ultrapure water to 8.0 ml of nitric acid such that the total amount is 50.00 g is measured as a blank, and the amount of the metal in the blank is subtracted.

<Measurement of Molecular Weight of Resin>

The molecular weight and molecular weight distribution of the resin used in the present invention are calculated in terms of polystyrene by gel permeation chromatography (GPC). The column elution rate of the resin having an acid group depends on the amount of the acid group, and unfortunately, an accurate molecular weight and molecular weight distribution are not measured. For this reason, a sample an acid group capped in advance needs to be prepared. Methyl esterification is preferable for the capping, and a commercially available methyl esterification agent can be used. Specifically, examples of the capping include a method for treating an acid group with trimethylsilyldiazomethane.

The measurement of the molecular weight by GPC is performed as follows. The resin is added to THF (tetrahydrofuran), and left as it is at room temperature for 24 hours. The thus-prepared solution is filtered with a solvent-resistant membrane filter “MAISHORI DISK” having a pore diameter of 0.2 μm (made by Tosoh Corporation) to obtain a sample solution. The sample solution is measured under the following conditions. In preparation of the sample, the amount of THF is adjusted such that the concentration of the resin is 0.8% by mass. If the resin is hardly dissolved in THF, a basic solvent such as DMF can be used:

apparatus: HLC8120 GPC (detector: RI) (made by Tosoh Corporation),

column: Shodex 7 columns of KF-801, KF-802, KF-803, KF-804, KF-805, KF-806, and KF-807 (made by Showa Denko K.K.),

eluent: tetrahydrofuran (THF),

flow rate: 1.0 ml/min,

oven temperature: 40.0° C., and

amount of sample to be used: 0.10 mL.

In calculation of the molecular weight of the sample, a molecular weight calibration curve is used, which is created using standard polystyrene resin columns below. Specifically, the standard polystyrene resin columns are trade names “TSK Standard Polystyrenes F-850, F-450, F-288, F-128, F-80, F-40, F-20, F-10, F-4, F-2, F-1, A-5000, A-2500, A-1000, and A-500” made by Tosoh Corporation.

<Method for Measuring Acid Value of Resin>

The acid value is the mass of potassium hydroxide in milligrams needed to neutralize acids contained in 1 g of the sample. The acid value in the present invention is measured according to JIS K 0070-1992, and specifically measured according to the following procedure.

Titration is performed using a 0.1 mol/L potassium hydroxide ethyl alcohol solution (made by KISHIDA CHEMICAL Co., Ltd.). The factor of the potassium hydroxide ethyl alcohol solution can be determined using a potentiometric titrator (potentiometric titrator AT-510 made by Kyoto Electronics Manufacturing Co., Ltd.). 100 mL of the 0.100 mol/L hydrochloric acid is placed in a 250 mL tall beaker, and titrated with the potassium hydroxide ethyl alcohol solution. The acid value is determined from the amount of the potassium hydroxide ethyl alcohol solution needed for neutralization. The 0.100 mol/L hydrochloric acid prepared according to JIS K 8001-1998 is used.

The measurement conditions in measurement of the acid value are shown below:

titrator: potentiometric titrator AT-510 (made by Kyoto Electronics Manufacturing Co., Ltd.),

electrode: composite glass electrode double junction type (made by Kyoto Electronics Manufacturing Co., Ltd.),

control software for titrator: AT-WIN, and

titration analyzing software: Tview.

The titration parameters and control parameters in titration are set as follows.

Titration Parameters

titration mode: blank titration

titration manner: total titration

the largest amount for titration: 20 mL

waiting time before titration: 30 seconds

titration direction: automatic

Control Parameters

potential in end point determination: 30 dE

potential value in end point determination: 50 dE/dmL

determination of detection of end point: not set

control rate mode: standard

gain: 1

potential in taking data: 4 mV

titration amount in taking data: 0.1 mL

Main test;

0.100 g of the sample for measurement is precisely weighed and placed in a 250 mL tall beaker. 150 mL of a mixed solution of toluene/ethanol (3:1) is added, and the sample is dissolved over 1 hour. Using the potentiometric titrator, the sample solution is titrated with the potassium hydroxide ethyl alcohol solution.

Blank test;

Titration is performed in the same manner as that in the operation above except that no sample is used (namely, only the mixed solution of toluene/ethanol (3:1) is used).

The obtained result is substituted into the following equation to calculate the acid value.

A=[(C−B)×f×5.611]/S

wherein A: acid value (mgKOH/g), B: the amount of the potassium hydroxide ethyl alcohol solution to be added (mL) in the blank test, C: the amount of the potassium hydroxide ethyl alcohol solution to be added (mL) in the main test, f: a factor of the potassium hydroxide solution, and S: sample (g).

<Methods for Measuring Weight Average Particle Diameter (D4) and Number Average Particle Diameter (D1) of Toner>

The weight average particle diameter (D4) and number average particle diameter (D1) of the toner are calculated as follows. As the measurement apparatus, an accurate particle size distribution measurement apparatus “Coulter Counter Multisizer 3” (registered trademark, made by Beckman Coulter, Inc.) including a 100 μm aperture tube and using a micropore electric resistance method is used. Setting of the measurement conditions and analysis of the measurement data are performed using the attached dedicated software “Beckman Coulter, Inc. Multisizer 3 Version 3.51” (made by Beckman Coulter, Inc.). The measurement is performed at 25,000 effective measurement channels.

As an electrolytic aqueous solution used for the measurement, those prepared by dissolving super grade sodium chloride in ion exchange water such that the concentration is 1% by mass, such as “ISOTON II” (made by Beckman Coulter, Inc.), can be used.

Before the measurement and analysis are performed, the dedicated software is set as follows. In the “Change standard measurement method (SOM)” screen in the dedicated software, the total count number in the control mode is set at 50000 particles, and the number of measurement is set at 1. As the Kd value, a value obtained using a “Standard Particle 10.0 μm” (made by Beckman Coulter, Inc.) is set. The threshold and the noise level are automatically set by pressing the “button for measuring threshold/noise level.” The current is set at 1600 μA, the gain is set at 2, and the electrolyte solution is set at ISOTON II. The “flush aperture tube after measurement” is checked. In the “setting of conversion from pulse to particle diameter” screen in the dedicated software, the bin interval is set at a logarithmic particle diameter, the particle diameter bin is set at 256 particle diameter bins, and the range of the particle diameter is set from 2 to 60 μm.

A specific measurement method is as follows.

(1) 200 mL of the electrolytic aqueous solution is placed in a 250 mL glass round-bottomed beaker dedicated to Multisizer 3. The beaker is set on a sample stand, and the electrolytic aqueous solution is stirred counterclockwise by a stirrer at 24 turns/sec. By the function of “flush aperture” in the dedicated software, dirt and air bubbles within the aperture tube are removed.

(2) 30 mL of the electrolytic aqueous solution is placed in a 100 mL glass flat-bottomed beaker. 0.3 mL of a diluted solution is put into the flat-bottomed beaker, the diluted solution being prepared by diluting “CONTAMINONN” (a 10% by mass aqueous solution of a neutral detergent for washing a precise measurement apparatus comprising a nonionic surface active agent, an anionic surface active agent, and an organic builder and having a pH of 7, made by Wako Pure Chemical Industries, Ltd.) as a dispersant 3 times by mass with exchange water.

(3) An ultrasonic disperser “Ultrasonic Dispension System Tetora 150” having an electric output of 120 W (made by Nikkaki-Bios Co., Ltd.) is prepared, the ultrasonic disperser including two built-in oscillators having an oscillating frequency of 50 kHz with the phase of one oscillator being shifted by 180° from the phase of the other oscillator. 3.3 L of ion exchange water is poured into the water bath in the ultrasonic disperser, and 2 mL of CONTAMINONN is added in the water bath.

(4) The flat-bottomed beaker in (2) is set in a beaker fixing hole in the ultrasonic disperser, and the ultrasonic disperser is activated. The height of the beaker is adjusted such that resonance of the solution surface of the electrolytic aqueous solution within the beaker is maximized.

(5) In the state where the electrolytic aqueous solution within the flat-bottomed beaker in (4) is irradiated with an ultrasonic wave, 10 mg of the toner is added to the electrolytic aqueous solution little by little, and dispersed. Then, the ultrasonic dispersion is continued for another 60 seconds. In the ultrasonic dispersion, the temperature of the solution in the water bath is properly adjusted to be not less than 10° C. and not more than 40° C.

(6) Using a pipette, the electrolyte aqueous solution in (5) having the toner dispersed is dropped into the round-bottomed beaker in (1) set in the sample stand, and the measurement concentration is adjusted to be 5%. Then, the measurement is performed until the number of measured particles reaches 50000.

(7) The measurement data is analyzed by the dedicated software attached to the apparatus, and the weight average particle diameter (D4) and the number average particle diameter (D1) are calculated. The weight average particle diameter (D4) is the “average diameter” on the “analysis/volume statistical value (arithmetic average)” screen when graph/% by volume is set by the dedicated software. The number average particle diameter (D1) is the “average diameter” on the “analysis/number statistical value (arithmetic average)” screen when graph/number % is set by the dedicated software.

### EXAMPLES

Hereinafter, using Examples, the present invention will be specifically described. In the present Examples, “parts” are based on mass.

Table 1 shows Production and Formula Examples of the examples of the metallic compound usable in the present invention. Further, Synthesis Examples of the metallic compounds used in Examples will be described in detail.

TABLE 1

| | Structure of aromatic compound | | | | | | |
|---|---|---|---|---|---|---|---|
| | | R₁ to R₃ | R₄ to R₈ | | | | |
| | | H, OH, | H, OH, and | | M1 | | Analyzed |
| | | COOH, and | alkyl or | | H, alkali | | data |
| | | alkyl or alkoxy | alkoxy | | metal, and | | Fluorescent |
| | | group of | group of | | NH4: | | X-ray |
| | | C = 1 to 18 | C = 1 to 19 | | ammonium | Metal | analysis |
| | | *Blanks | *Blanks | | atomic group | reagent | (contained |
| Metallic | | designate | designate | n | or mixture | used for | metal, % |
| compound | Structural Formula | R = H. | R = H. | 1 to 3 | thereof | reaction | by mass) |
| A | 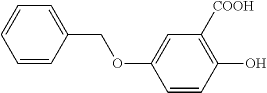 [SMILES: O=C(O)c1cc(OCc2ccccc2)ccc1O] | | | 1 | H | Aluminum sulfate | Al: 4.24 |
| B | 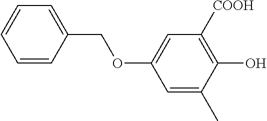 [SMILES: Cc1cc(OCc2ccccc2)cc(C(=O)O)c1O] | 3-Me | | 1 | H | Aluminum sulfate | Al: 3.98 |
| C | 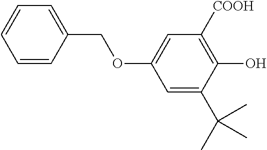 [SMILES: CC(C)(C)c1cc(OCc2ccccc2)cc(C(=O)O)c1O] | 3-tert-Butyl | | 1 | H | Aluminum sulfate | Al: 5.31 |
| D | 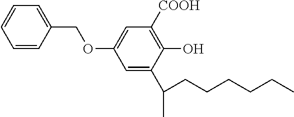 [SMILES: CCCCCCC(C)c1cc(OCc2ccccc2)cc(C(=O)O)c1O] | 3-iso-Octyl | | 1 | H | Aluminum sulfate | Al: 3.09 |
| E | 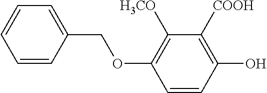 [SMILES: COc1c(OCc2ccccc2)ccc(O)c1C(=O)O] | 6-Meo | | 1 | H | Aluminum sulfate | Al: 4.44 |
| F | 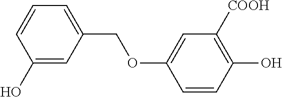 | | 3-OH | 1 | H | Aluminum sulfate | Al: 3.52 |
| G | 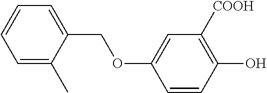 [SMILES: Cc1ccccc1COc1ccc(O)c(C(=O)O)c1] | | 2-Me | 1 | H | Aluminum sulfate | Al: 4.07 |
| H | 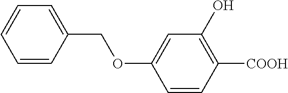 | | | 1 | H | Aluminum sulfate | Al: 4.61 |
| I | 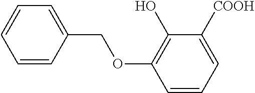 [SMILES: O=C(O)c1cccc(OCc2ccccc2)c1O] | | | 1 | H | Aluminum sulfate | Al: 4.80 |
| J | 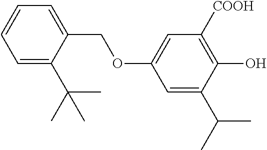 [SMILES: CC(C)c1cc(OCc2ccccc2C(C)(C)C)cc(C(=O)O)c1O] | 3-iso-Propyl | 2-tert-Butyl | 1 | H | Aluminum sulfate | Al: 3.14 |
| K | 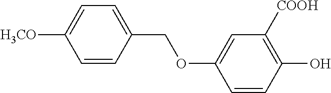 [SMILES: COc1ccc(COc2ccc(O)c(C(=O)O)c2)cc1] | | 4-Meo | 1 | H | Aluminum sulfate | Al: 3.38 |
| L | 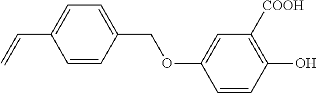 [SMILES: C=Cc1ccc(COc2ccc(O)c(C(=O)O)c2)cc1] | | 4-Vinyl | 1 | H | Aluminum sulfate | Al: 4.13 |
| N | 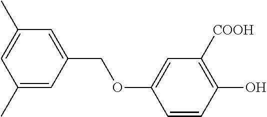 [SMILES: Cc1cc(C)cc(COc2ccc(O)c(C(=O)O)c2)c1] | | 3-Me 5-Me | 1 | H | Aluminum sulfate | Al: 3.86 |
| O | 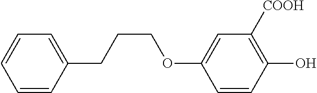 [SMILES: O=C(O)c1cc(OCCCc2ccccc2)ccc1O] | | | 3 | H | Aluminum sulfate | Al: 3.95 |
| P | 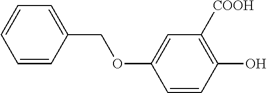 [SMILES: O=C(O)c1cc(OCc2ccccc2)ccc1O] | | | 1 | H | Zinc chloride | Zn: 10.36 |
| Q | 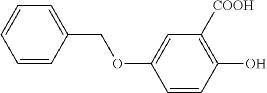 [SMILES: O=C(O)c1cc(OCc2ccccc2)ccc1O] | | | 1 | H | Chromium sulfate | Cr: 12.32 |

<Synthesis Example of Metallic Compound A>

(Step 1)

100.0 g of 2,5-dihydroxybenzoic acid was dissolved in 2 L of methanol, and 88.3 g of potassium carbonate was added. The solution was heated to 67° C. 84.6 g of chloromethylbenzene was dropped into the reaction solution over 20 minutes, and the reaction was made at 67° C. for 12 hours. The reaction solution was cooled, and methanol was distilled away under reduced pressure. The obtained product was washed with hexane. The residue was dissolved in methanol. The solution was dropped into water, and reprecipitated. The precipitate was filtered. The reprecipitation operation was repeated twice in total, and the residue was dried at 80° C. for 48 hours to obtain 40.8 g of an aromatic compound represented by formula (6) below:

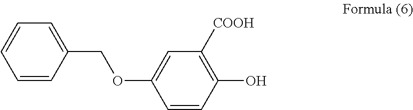 [SMILES: O=C(O)c1cc(OCc2ccccc2)ccc1O]

(Step 2)

16.2 g of a 20.5% sodium hydroxide solution was added to 130 ml of water, and 9.76 g of the aromatic compound was added thereto. The solution was heated to 90° C. A solution prepared by adding 77.2 g of a 25.7% aluminum sulfate aqueous solution to 440 mL of water and heating the aluminum sulfate aqueous solution to 90° C. was dropped into the solution above over 30 minutes. The obtained solution was heated to 95° C., and heated and stirred for 2 hours. After the reaction, the solution was cooled to room temperature, and filtered. The obtained product was washed with water such that the electric conductivity thereof reached 300 μS/cm or less. Subsequently, the obtained product was dried at 80° C. for 14 hours to obtain 9.6 g of light brown Metallic Compound A.

<Synthesis Example of Metallic Compound C>

(Step 1)

100 g of 2,5-dihydroxybenzoic acid and 1441 g of 80% sulfuric acid are heated to 50° C. and mixed. 144 g of tert-butyl alcohol was added to the dispersion liquid, and the dispersion liquid was stirred at 50° C. for 30 minutes. Subsequently, 144 g of tert-butyl alcohol was added to the dispersion liquid, and the dispersion liquid was stirred for 30 minutes. The operation was performed three times in total. The reaction solution was cooled to room temperature, and poured into 1 kg of ice water gradually. The precipitate was filtered, washed with water, and further washed with hexane. The precipitate obtained was dissolved in 200 ml of methanol, and reprecipitated in 3.6 L of water. After filtration, the obtained product was dried at 80° C. for 24 hours to obtain 74.9 g of a salicylic acid intermediate product represented by formula (7) below:

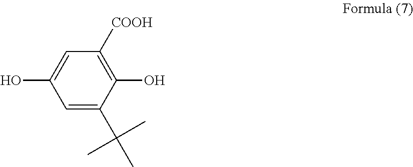

(Step 2)

25.0 g of the salicylic acid intermediate product was dissolved in 150 mL of methanol, and 36.9 g of potassium carbonate was added thereto. The solution was heated to 65° C. A dissolution solution prepared by mixing 15.5 g of chloromethylbenzene with 100 mL of methanol and dissolving chloromethylbenzene in methanol was dropped into the reaction solution, and the reaction was made at 65° C. for 3 hours. The reaction solution was cooled, and filtered. Methanol in the filtrate was distilled away under reduced pressure to obtain a precipitate. The precipitate was dispersed in 1.5 L of water at pH=2, and ethyl acetate was added to perform extraction. Subsequently, the extracted product was washed with water, and dried with magnesium sulfate. Ethyl acetate was distilled away under reduced pressure to obtain a precipitate. Further, the precipitate was washed with hexane, and recrystallized with toluene and ethyl acetate to obtain 17.7 g of an aromatic compound represented by formula (8) below:

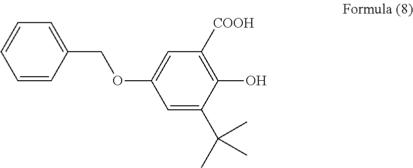 [SMILES: CC(C)(C)c1cc(OCc2ccccc2)cc(C(=O)O)c1O]

(Step 3)

70.4 g of a 20% sodium hydroxide solution was added to 400 mL of water, and 36.8 g of the aromatic compound was added. The solution was heated to 90° C. A solution prepared by adding 60.0 g of a 25.7% aluminum sulfate aqueous solution to 340 mL of water and heating the solution to 90° C. was added to the solution above over 30 minutes. The mixed solution was heated and stirred at 95° C. for 2 hours. Subsequently, the mixed solution was filtered. The obtained product was washed with water until the electric conductivity of the filtrate reached 300 μS/cm or less. The obtained was dried at 80° C. for 48 hours to obtain 36.0 g of white Metallic Compound C.

<Synthesis Example of Metallic Compound D>

(Step 1)

An aromatic compound represented by formula (9):

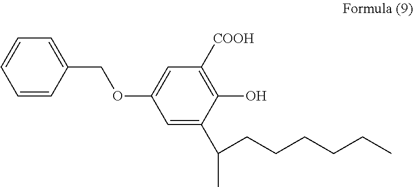 [SMILES: CCCCCCC(C)c1cc(OCc2ccccc2)cc(C(=O)O)c1O]

was obtained by the same method as that in Synthesis Example of Metallic Compound A except that 2,5-dihydroxybenzoic acid in Synthesis Example of Metallic Compound A was replaced by 173.2 g of 3,6-dihydroxy-5-isooctylbenzoic acid.

(Step 2)

12.3 g of a metallic compound was obtained by the same method as that in Synthesis Example of Metallic Compound A except that the aromatic compound in Step 2 of Synthesis Example of Metallic Compound A was replaced by 14.2 g of an aromatic compound represented by formula (9).

<Synthesis Example of Metallic Compound E>

(Step 1)

An aromatic compound represented by formula (10):

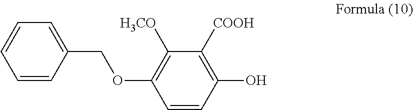 [SMILES: COc1c(OCc2ccccc2)ccc(O)c1C(=O)O]

was obtained by the same method as that in Synthesis Example of Metallic Compound A except that 2,5-dihydroxybenzoic acid in Synthesis Example of Metallic Compound A was replaced by 119.5 g of 3,6-dihydroxy-2-methoxybenzoic acid.

(Step 2)

10.9 g of a metallic compound was obtained by the same method as that in Synthesis Example of Metallic Compound A except that the aromatic compound in Step 2 of Synthesis Example of Metallic Compound A was replaced by 11.0 g of the aromatic compound represented by formula (10).

<Synthesis Example of Metallic Compound H>

(Step 1)

An aromatic compound represented by formula (11):

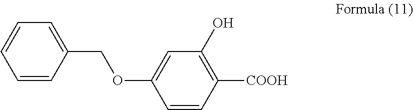 [SMILES: O=C(O)c1ccc(OCc2ccccc2)cc1O]

was obtained by the same method as that in Synthesis Example of organic Metallic Compound A except that 2,5-dihydroxybenzoic acid in Synthesis Example of Metallic Compound A was replaced by 2,4-dihydroxybenzoic acid.

(Step 2)

9.2 g of a metallic compound was obtained by the same method as that in Synthesis Example of Metallic Compound A except that the aromatic compound in Step 2 of Synthesis Example of Metallic Compound A was replaced by the aromatic compound represented by formula (11).

<Synthesis Example of Metallic Compound I>

(Step 1)

An aromatic compound represented by formula (12):

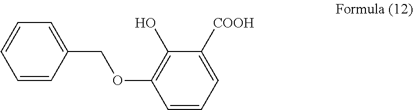 [SMILES: O=C(O)c1cccc(OCc2ccccc2)c1O]

was obtained by the same method as that in Synthesis Example of Metallic Compound A except that 2,5-dihydroxybenzoic acid in Synthesis Example of organic Metallic Compound A was replaced by 2,3-dihydroxybenzoic acid.

(Step 2)

8.7 g of a metallic compound was obtained by the same method as that in Synthesis Example of Metallic Compound A except that the aromatic compound in Step 2 of Synthesis Example of Metallic Compound A was replaced by the aromatic compound represented by formula (12).

<Synthesis Example of Metallic Compound L>

(Step 1)

48.7 g of An aromatic compound represented by formula (13):

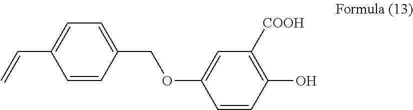 [SMILES: C=Cc1ccc(COc2ccc(O)c(C(=O)O)c2)cc1]

was obtained by the same method as that in Synthesis Example of Metallic Compound A except that chloromethylbenzene in Synthesis Example of Metallic Compound A was replaced by 102.0 g of 4-(chloromethyl) styrene.

(Step 2)

10.5 g of a light brown metallic compound was obtained by the same method as that in Synthesis Example of Metallic Compound A except that the aromatic compound in Step 2 of Synthesis Example of Metallic Compound A was replaced by 10.8 g of the aromatic compound represented by formula (13).

<Synthesis Example of Metallic Compound N>

(Step 1)

An aromatic compound represented by formula (14):

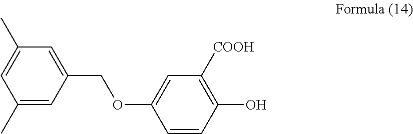 [SMILES: Cc1cc(C)cc(COc2ccc(O)c(C(=O)O)c2)c1]

was obtained by the same method as that in Synthesis Example of Metallic Compound A except that chloromethylbenzene in Synthesis Example of Metallic Compound A was replaced by 3,5-dimethyl-chloromethylbenzene.

(Step 2)

9.7 g of Metallic Compound N was obtained by the same method as that in Synthesis Example of Metallic Compound A except that the aromatic compound in Step 2 of Synthesis Example of Metallic Compound A was replaced by 11.0 g of the aromatic compound represented by formula (14).

<Synthesis Example of Metallic Compound 0>

(Step 1)

An aromatic compound represented by formula (15):

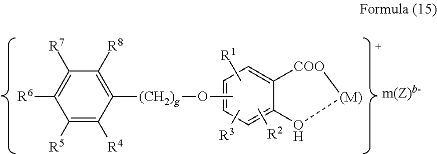

was obtained by the same method as that in Synthesis Example of Metallic Compound A except that chloromethylbenzene in Synthesis Example of Metallic Compound A was replaced by 3-chloropropylbenzene.

(Step 2)

9.9 g of Metallic Compound 0 was obtained by the same method as that in Synthesis Example of Metallic Compound A except that the aromatic compound in Step 2 of Synthesis Example of Metallic Compound A was replaced by 10.96 g of the aromatic compound represented by formula (15).

<Synthesis Example of Metallic Compound P>

10.8 g of the aromatic compound produced in Synthesis Example of Metallic Compound A, and 16.2 g of a 20.5% sodium hydroxide aqueous solution were added to 500 ml of water, and the solution was heated to 90° C. 59.4 g of a 26.8% zinc chloride aqueous solution was dropped to this solution over 30 minutes. The obtained solution was heated to 95° C., and reacted for 2 hours, cooled to room temperature, and filtered. The obtained product was washed with water. The product was dried at 80° C. overnight, and 13.1 g of white Metallic Compound P was obtained.

<Synthesis Example of Metallic Compound Q>

10.8 g of the aromatic compound produced in Synthesis Example of Metallic Compound A, and 16.2 g of a 20.5% sodium hydroxide aqueous solution were added to 500 ml of water, and the solution was heated to 90° C. 81.2 g of a 28.0% chromium sulfate aqueous solution was dropped into the heated solution over 30 minutes. The obtained solution was heated to 95° C., and reacted for 2 hours, cooled to room temperature, and filtered. The obtained product was washed with water. The obtained product was dried at 80° C. overnight to obtain 14.5 g of white Metallic Compound Q.

<Synthesis Example of Polyester PES-1>

| | |
|---|---|
| bisphenol A propylene oxide 2.2 mol adduct | 65.0 parts |
| terephthalic acid | 3.0 parts |
| dimethyl terephthalate | 32.0 parts |
| dibutyltin oxide | 0.005 parts |

These materials were placed in a 4 L glass four-necked flask. A thermometer, a stirring rod, a condenser, and a nitrogen introducing pipe were attached to the flask. The flask was placed in a mantle heater. The reaction was made at 220° C. for 5 hours under a nitrogen atmosphere to obtain Polyester Resin PES-1.

<Synthesis Example of Polyester PES-2>

| | |
|---|---|
| bisphenol A propylene oxide 2.2 mol adduct | 67.8 parts |
| terephthalic acid | 22.2 parts |
| trimellitic anhydride | 10.0 parts |
| dibutyltin oxide | 0.005 parts |

These materials were placed in a four-necked flask. A thermometer, a stirring rod, a condenser, and a nitrogen introducing pipe were attached to the flask. The reaction was made at 220° C. for 5 hours under a nitrogen atmosphere to obtain Polyester Resin PES-2.

<Synthesis Example of Hybrid Resin HB-1>

| | |
|---|---|
| bisphenol A propylene oxide 2.2 mol adduct | 69.0 parts |
| terephthalic acid | 28.0 parts |
| fumaric acid | 3.0 parts |
| dibutyltin oxide | 0.005 parts |

These were placed in a four-necked flask. A thermometer, a stirring rod, a condenser, and a nitrogen introducing pipe were attached to the flask. The reaction was made at 220° C. for 5 hours under a nitrogen atmosphere to obtain a polyester resin.

200 parts of xylene was placed in a reaction container having a stirrer, a condenser, a thermometer, and a nitrogen introducing pipe attached thereto, and was refluxed under a nitrogen stream. 70 parts of the polyester resin produced above was placed in the reaction container, and dissolved.

Next, these materials:

| | |
|---|---|
| styrene | 79.0 parts |
| n-butyl acrylate | 20.3 parts |
| acrylic acid | 0.7 parts |
| dimethyl-2,2′-azo-bis(2-methylpropionate) | 1.5 parts |

were mixed, and dropped into the reaction container while the solution in the reaction container was stirred. The obtained solution was kept for 10 hours. Subsequently, the solvent was distilled away by distillation. The obtained product was dried under reduced pressure at 40° C. to obtain Hybrid Resin HB-1.

The compositions and physical properties of PES-1, PES-2, and HB-1 will be shown together in Table 2.

Hereinafter, Toners 1 to 28 according to the present invention are produced by a method described below.

### Example 1

<Production Example of Toner 1>

| | |
|---|---|
| Polyester PES-1 | 100.0 parts |
| Metallic Compound A | 0.42 parts |
| copper phthalocyanine (C.I. Pigment Blue 15:3: made by | 5.0 parts |
| Dainichiseika Color & Chemicals Mfg. Co., Ltd.) | |
| paraffin wax (HNP-7: made by Nippon Seiro Co., Ltd.) | 3.0 parts |

The toner materials were sufficiently premixed by a Henschel mixer (made by Mitsui Miike Kakoki K.K.), and melt kneaded by a twin screw extruder, and cooled. Using a hammer mill, the kneaded product was crushed into a particle diameter of approximately 1 to 2 mm. Next, the crushed product was pulverized by an air jet pulverizer. Further, the pulverized product was classified by a multi classifier to obtain toner particles.

1.0 part of hydrophobic silica fine powder having a BET of 200 m²/g was externally added based on 100 parts of the toner resin particle by the Henschel mixer to obtain Toner 1. Physical properties of the toners according to Examples are shown in Table 3-1. The toners were evaluated as follows, and results of evaluation are shown in Table 3-2.

<Evaluation of Toner Charging Amount>

A two-component developer was produced as follows.

A sample was prepared as follows in order to evaluate the charging amount. 288 g of a magnetic carrier F813-300 (made by Powdertech Co., Ltd.) and 12 g of a toner to be evaluated were placed in a plastic bottle with a cover. The bottle was shaken by a shaker (YS-LD: made by YAYOI CO., LTD.) at a rate of 200 times/min for 1 minute.

<Evaluation of Toner Charging Amount Under High Temperature and High Humidity>

In measurement of the charging amount of the toner, 30 g of the developer was taken, and left as it was under an high temperature and high humidity environment (30° C./80%) for three days and nights. Subsequently, the developer was placed in a 50 mL insulative plastic container. The container was shaken 500 times at a rate of 200 times/min. The charging amount was measured using an apparatus illustrated in FIGURE. The absolute value of the charging amount was measured, and evaluation was performed according to the criterion below:

A rank: not less than 45.0 mC/kg
B rank: not less than 30.0 mC/kg and less than 45.0 mC/kg
C rank: not less than 15.0 mC/kg and less than 30.0 mC/kg
D rank: less than 15.0 mC/kg

(Method of Measuring Charging Amount)

0.5 g of a developer, whose frictional charge amount was to be measured, was placed in metallic measurement container 2 illustrated in FIGURE, in which a 500-mesh screen 3 (opening of 25 μm) was provided in the bottom of the container 2. The container 2 was covered with a metallic cover 4. The total mass of the measurement container 2 was weighed, and the mass was defined as W1 (g). Next, in a sucker 1 (a portion contacting the measurement container 2 is at least an insulating body), the developer was sucked from the suction port 7. By adjusting an air amount control valve 6, the pressure at a vacuum gauge 5 was controlled to be 250 mmAq. In this state, the developer was sufficiently suctioned, and preferably for 2 minutes. Thereby, the toner was sucked and removed.

The potential of an electrometer 9 at this time was defines as V (volt). The capacitance of a capacitor 8 was defines as C (μF). The total mass of the measurement container after suction was weighed, and defined as W2 (g). The frictional charge amount of the toner was calculated by the equation:

frictional charge amount (mC/kg; μC/g)=(C×V)/(W1−W2)

<Evaluation of Dependency of Toner Charging Amount on Environment>

The toner charging amount was measured by the same method as that in the evaluation of the toner charging amount under the high temperature and high humidity except that the developer was left as it was under a low temperature and low humidity environment (15° C./10%). The absolute value of the ratio of the charging amount at a low temperature and low humidity to that at a high temperature and high humidity (charging amount under low temperature and low humidity/charging amount under high temperature and high humidity) was calculated, and evaluation was performed according to the criterion below:

A rank: less than 1.30
B rank: not less than 1.30 and less than 1.50
C rank: not less than 1.50 and less than 2.00
D rank: not less than 2.00

<Evaluation of Rising Property of Toner Charging Amount>

270 g of the two-component developer was taken, and left as it was under a high temperature and high humidity environment (30° C./80% RH) for three days and nights. The two-component developer was put into a developing unit of a color laser copier CLC5500 (made by Canon Inc.), and the developing unit was idly rotated at 240 rpm using an idling apparatus including an external motor. The developing unit was rotated for 2 minutes (Q2 min) and further rotated for 3 minutes (Q5 min). The two-component developer on the developing sleeve was extracted at Q2 min and Q5 min, and the charging amounts of the extracted developers were measured by the apparatus illustrated in FIGURE. The ratio (Q5 min/Q2 min) was calculated, and evaluation was performed according to the criterion below:

A rank: less than 1.20
B rank: not less than 1.20 and less than 1.40
C rank: not less than 1.40 and less than 1.60
D rank: not less than 1.60

<Evaluation of Change in Charging Amount when Toner is Left Under High Temperature and High Humidity>

The produced toner for evaluation was evaluated according to the following procedure.

0.60 g of the toner for evaluation was weighed and placed in a 50 mL plastic bottle, and the bottle was left as it was under an high temperature and high humidity environment (50° C./95% RH) for three days. The bottle was further left as it was under a normal temperature and normal humidity (23° C., 55% RH) environment for three days. The toner was mixed with 29.40 g of the magnetic carrier F813-300 (made by Powdertech Co., Ltd.). The mixture was shaken by a shaker (YS-LD: made by YAYOI CO., LTD.) at a rate of 200 times/min for 1 minute.

Similarly, 0.60 g of the toner for evaluation was weighed and placed in a 50 mL plastic bottle. Instead of the high temperature and high humidity, the bottle was left as it was under the normal temperature and normal humidity environment for three days. The toner was mixed with 29.4 g of the magnetic carrier, and the mixture was shaken in the same manner as above.

In the produced samples for evaluation of charging, the charging amount was measured by the apparatus illustrated in FIGURE. The ratio of the charging amount of the sample left under the high temperature and high humidity environment to that of the sample not left under the high temperature and high humidity environment was calculated, and stability when the toner was left under the high temperature and high humidity environment was determined according to the criterion below:

A rank: not less than 0.85
B rank: not less than 0.80 and less than 0.85
C rank: not less than 0.70 and less than 0.80
D rank: less than 0.70

<Evaluation of Pigment Dispersibility>

In order to evaluate pigment dispersibility of the toner, a super thin section of the toner was produced by a microtome, and observed by a transmission electron microscope (TEM). When necessary, the section was stained by ruthenium oxide or osmic acid. The criterion of evaluation depends on the pigments. It was observed whether the pigment was dispersed at a primary particle diameter, and whether segregation of the pigment and bleeding of the pigment onto the surface layer of the toner were found, and the toners were ranked according to the criterion below:

A rank: the pigment is dispersed at the primary particle diameter, and uniformly exists in the entire toner;
B rank: the aggregated pigment is partially found, and unevenly exists; and
C rank: the pigment is aggregated, and a large amount of the pigment bled onto the surface of the toner is found.

<Evaluation of Reproducibility of Halftone>

Evaluation was performed using the two-component developer and the color laser copier CLC5500 (made by Canon Inc.). A fixed image was formed on a paper (paper TKCLA4 for the color laser copier, made by Canon Inc.) with the amount of the toner to be applied being changed at seven levels. The amount of the toner to be applied was 0.10 mg/cm², 0.20 mg/cm², 0.30 mg/cm², 0.40 mg/cm², 0.50 mg/cm², 0.60 mg/cm², and 0.70 mg/cm².

(Evaluation of Color Toner)

In fixed images of color toners, using a Spectroscan made by Gretag Macbeth GmbH (measurement conditions: D65, viewing angle of 2°), CIE and b* were measured. The chromaticity against the amount of the toner to be applied at seven levels was plotted, and a smooth curve line was drawn to connect points. The relationship between C* and L* was determined. From the relationship, the value of C* at L*=70 and the value of L* at C*=50 were determined. The value of C* can be determined by C*=((a*)²+(b*)²)^{1/2}.

(Criterion of Evaluation of Color Toner)

A rank: the value of C* at L*=70 is not less than 35.0, and the value of L* at C*=50 is not less than 65.0 (image has high saturation);

B rank: the value of C* at L*=70 is not less than 30.0, and the value of L* at C*=50 is not less than 60.0 (color Reproducibility is narrower, but a good image is obtained); and

C rank: the value of C* at L*=70 is less than 30.0, or the value of L* at C*=50 is less than 60.0 (color Reproducibility is poor).

(Evaluation of Black Toner)

As described above, a fixed image was produced in the same manner as in the case of evaluation of the color toner. In the fixed images of the black toner, the image density was measured by a Macbeth reflection densitometer (made by Gretag Macbeth GmbH).

(Criterion of Evaluation of Black Toner)

The ratio of the difference (D0.4−D0.3) between the image density at the amount of the toner to be applied of 0.30 mg/cm² and that at 0.40 mg/cm² to the image density (D0.7) at the amount of the toner to be applied of 0.7 mg/cm² was determined, and evaluation was performed as follows:

A rank: (D0.4−D0.3)/(D0.7)<1.10
B rank: 1.10≦(D0.4−D0.3)/(D0.7)<1.25
C rank: 1.25≦(D0.4−D0.3)/(D0.7)

### Example 2

Toner 2 was obtained by performing the same operation as that in Production Example of Toner 1 except that Metallic Compound A was replaced by 0.34 parts of Metallic Compound C. Toner 2 was evaluated in the same manner as in Example 1, and the result of evaluation is shown in Table 3-2.

### Example 3

Toner 3 was obtained by performing the same operation as that in Production Example of Toner 1 except that Metallic Compound A was replaced by 0.40 parts of Metallic Compound E. Toner 3 was evaluated in the same manner as in Example 1, and the result of evaluation is shown in Table 3-2.

### Example 4

Toner 4 was obtained by performing the same operation as that in Production Example of Toner 1 except that Metallic Compound A was replaced by 0.39 parts of Metallic Compound H. Toner 4 was evaluated in the same manner as in Example 1, and the result of evaluation is shown in Table 3-2.

### Example 5

Toner 5 was obtained by performing the same operation as that in Production Example of Toner 1 except that Metallic Compound A was replaced by 0.37 parts of Metallic Compound I. Toner 5 was evaluated in the same manner as in Example 1, and the result of evaluation is shown in Table 3-2.

### Example 6

Toner 6 was obtained by performing the same operation as that in Production Example of Toner 1 except that Metallic Compound A was replaced by 0.58 parts of Metallic Compound D. Toner 6 was evaluated in the same manner as in Example 1, and the result of evaluation is shown in Table 3-2.

### Example 7

Toner 7 was obtained by performing the same operation as that in Production Example of Toner 1 except that Metallic Compound A was replaced by 0.43 parts of Metallic Compound L. Toner 7 was evaluated in the same manner as in Example 1, and the result of evaluation is shown in Table 3-2.

### Example 8

Toner 8 was obtained by performing the same operation as that in Production Example of Toner 1 except that Metallic Compound A was replaced by 0.46 parts of Metallic Compound N. Toner 8 was evaluated in the same manner as in Example 1, and the result of evaluation is shown in Table 3-2.

### Example 9

Toner 9 was obtained by performing the same operation as that in Production Example of Toner 1 except that Metallic Compound A was replaced by 0.45 parts of Metallic Compound 0. Toner 9 was evaluated in the same manner as in Example 1, and the result of evaluation is shown in Table 3-2.

### Example 10

Toner 10 was obtained by performing the same operation as that in Production Example of Toner 1 except that Metallic Compound A was replaced by 0.42 parts of Metallic Compound P. Toner 10 was evaluated in the same manner as in Example 1, and the result of evaluation is shown in Table 3-2.

### Example 11

Toner 11 was obtained by performing the same operation as that in Production Example of Toner 1 except that Metallic Compound A was replaced by 0.28 parts of Metallic Compound Q. Toner 11 was evaluated in the same manner as in Example 1, and the result of evaluation is shown in Table 3-2.

### Example 12

Toner 12 was obtained by performing the same operation as that in Production Example of Toner 1 except that Polyester PES-1 was replaced by PES-2, and the amount of Metallic Compound A to be used was changed to 0.030 parts. Toner 12 was evaluated in the same manner as in Example 1, and the result of evaluation is shown in Table 3-2.

### Example 13

Toner 13 was obtained by performing the same operation as that in Production Example of Toner 1 except that Polyester PES-1 was replaced by PES-2, and the amount of Metallic Compound A to be used was changed to 0.090 parts. Toner 13 was evaluated in the same manner as in Example 1, and the result of evaluation is shown in Table 3-2.

### Example 14

Toner 14 was obtained by performing the same operation as that in Production Example of Toner 1 except that Polyester PES-1 was replaced by PES-2, and the amount of Metallic Compound A to be used was changed to 6.90 parts. Toner 14 was evaluated in the same manner as in Example 1, and the result of evaluation is shown in Table 3-2.

### Example 15

Toner 15 was obtained by performing the same operation as that in Production Example of Toner 1 except that Polyester PES-1 was replaced by PES-2, and the amount of Metallic Compound A to be used was changed to 7.90 parts. Toner 15 was evaluated in the same manner as in Example 1, and the result of evaluation is shown in Table 3-2.

### Example 16

Toner 16 was obtained by performing the same operation as that in Production Example of Toner 1 except that Polyester PES-1 was replaced by Hybrid Resin HB-1. Toner 16 was evaluated in the same manner as in Example 1, and the result of evaluation is shown in Table 3-2.

### Example 17

Production of Pigment Dispersed Paste:

| | |
|---|---|
| styrene monomer | 80.0 parts |
| Cu phthalocyanine (C.I. Pigment Blue 15:3: made by | 13.0 parts |
| Dainichiseika Color & Chemicals Mfg. Co., Ltd.) | |
| Metallic Compound A | 1.0 part |

The materials were sufficiently premixed in a container. While the premixture was kept at a temperature of not more than 20° C., the mixture was dispersed by a bead mill for 4 hours to produce a pigment dispersed paste.

Production of Toner Particle:

390 parts of a 0.1 mol/L-Na PO₄ aqueous solution was poured into 1150 parts of ion exchange water, and the solution was heated to 60° C. Then, using a CLEARMIX (made by M Technique Co., Ltd.), the solution was stirred at 13,000 rpm. 58 parts of a 1.0 mol/L-CaCl₂ aqueous solution was added to the solution to obtain a dispersion medium containing Ca₃(PO₄)₂.

| | |
|---|---|
| the pigment dispersed paste | 47.0 parts |
| styrene monomer | 42.0 parts |
| n-butyl acrylate | 18.0 parts |
| ester wax | 13.0 parts |
| (main component C₁₉H₃₉COOC₂₀H₄₁, | |
| melting point of 68.6° C.) | |
| Polyester Resin PES-2 | 5.0 parts |

These were heated to 60° C., and dissolved and dispersed to produce a monomer mixture. While the monomer mixture was kept at 60° C., 3.0 parts of 2,2′-azo-bis(2,4-dimethylvaleronitrile) as a polymerization initiator was added and dissolved to prepare a monomer composition. The monomer composition was added to the dispersion medium. Using the Clearmix, stirring was performed at 60° C. under a nitrogen atmosphere at 13000 rpm for 15 minutes to granulate the monomer composition. Subsequently, while stirring was performed by a paddle stirring blade, the reaction was made at 60° C. for 5 hours. Then, stirring was performed at 80° C. for 5 hours, and the polymerization was completed. The obtained product was cooled to room temperature. Hydrochloric acid was added to dissolve Ca₃(PO₄)₂. The suspension was filtered, and the obtained product was washed with water, and dried. Thereby, toner particles were obtained.

Further, the toner particles were classified. Hydrophobic silica fine powder was externally added to the toner particles in the same manner as in Production Example of Toner 1. Thus, Toner 17 was obtained. Toner 17 was evaluated in the same manner as in Example 1, and the result of evaluation is shown in Table 3-2.

### Example 18

Preparation of Toner Composition Mixed Solution:

| | |
|---|---|
| Polyester Resin PES-1 | 100.0 parts |
| Metallic Compound A | 4.4 parts |
| copper phthalocyanine (C.I. Pigment Blue 15:3: made by | 5.0 parts |
| Dainichiseika Color & Chemicals Mfg. Co., Ltd.) | |
| paraffin wax (HNP-7: made by Nippon Seiro Co., Ltd.) | 8.0 parts |
| ethyl acetate | 100.0 parts |

The materials were sufficiently premixed in a container. While the premixture was kept at not more than 20° C., the premixture was dispersed by a bead mill for 4 hours to produce a toner composition mixed solution.

Production of Toner Particle:

78 parts of a 0.1 mol/L-Na₃PO₄ aqueous solution was added to 240 parts of ion exchange water. The solution was heated to 60° C., and stirred at 14,000 rpm using a CLEARMIX (made by M Technique Co., Ltd.). 12 parts of a 1.0 mol/L-CaCl₂ aqueous solution was added to the solution to obtain a dispersion medium containing Ca₃(PO₄)₂. Further, 1.0 part of carboxymethyl cellulose (trade name: Celogen BS-H, made by Dai-ichi Kogyo Seiyaku Co., Ltd.) was added, and the dispersion medium was stirred for 10 minutes.

The temperature of the dispersion medium prepared in a container in the homomixer was adjusted to 30° C. While the dispersion medium was stirred, 180 parts of the toner composition mixed solution whose temperature was adjusted to 30° C. was added to the dispersion medium. Stirring was performed for 1 minute, and stopped. Thereby, a toner composition dispersed suspension was obtained. While the toner composition dispersed suspension was stirred, a gaseous phase on the surface of the suspension was forcibly renewed at a fixed temperature of 40° C. by an air exhausting apparatus. The suspension was kept as it was for 17 hours, and the solvent was removed. The suspension was cooled to room temperature, and hydrochloric acid was added to dissolve Ca₃(PO₄)₂. The suspension was filtered, and the obtained product was washed with water, dried, and classified. Thereby, toner particles were obtained.

Hydrophobic silica fine powder was externally added to the toner particles in the same manner as in Production Example of Toner 1. Thereby, Toner 18 was obtained. Toner 18 was evaluated in the same manner as in Example 1, and the result of evaluation is shown in Table 3-2.

### Example 19

Production Resin Dispersion Liquid:

| | |
|---|---|
| styrene | 78.0 parts |
| n-butyl acrylate | 20.0 parts |
| methacrylic acid | 2.0 parts |
| dodecanethiol | 6.0 parts |
| carbon tetrabromide | 1.0 part |

In a flask, 1.5 parts of a nonionic surfactant NONIPOL 400 and 2.5 parts of an anionic surface surfactant NEOGEN SC were dissolved in 140 parts of ion exchange water. The materials mixed and dissolved were dispersed and emulsified in the flask. While mixing was slowly performed for 10 minutes, 10 parts of ion exchange water having 1.0 part of ammonium persulfate dissolved therein was added. While replacement with nitrogen was performed, the flask was heated by an oil bath until the temperature of the content reached 70° C. The emulsion polymerization was continued as it was for 5 hours. Thereby, a resin dispersion liquid having a central diameter of 145 nm, a glass transition temperature of 58° C., and an Mw of 11200 was obtained.

Preparation of Blue Pigment Dispersion Liquid:

The composition below was mixed and dissolved, and dispersed by a homogenizer (IKA Works GmbH & Co. KGULTRA-TURRAX) and irradiation with an ultrasonic wave. Thereby, a blue pigment dispersion liquid having a central particle diameter of 140 nm was obtained.

| | |
|---|---|
| copper phthalocyanine (C.I. Pigment Blue 15:3: made by | 100.0 parts |
| Dainichiseika Color & Chemicals Mfg. Co., Ltd.) | |
| Metallic Compound A | 6.77 parts |
| anionic surfactant NEOGEN SC | 10.0 parts |
| ion exchange water | 400.0 parts |

Preparation of Mold Release Agent Dispersion Liquid:

The composition below was mixed, heated to 97° C., and dispersed by an ULTRA-TURRAX T50 made by IKA Works GmbH & Co. KG. Subsequently, the solution was dispersed by a Gaulin Homogenizer (made by Meiwafosis Co., Ltd.). The dispersion was performed under the conditions of 105° C. and 550 kg/cm² 20 times to obtain a mold release agent dispersion liquid having a central diameter of 190 nm.

| | |
|---|---|
| paraffin wax (HNP-7: made by Nippon Seiro Co., Ltd.) | 100.0 parts |
| anionic surfactant NEOGEN SC | 5.0 parts |
| ion exchange water | 300.0 parts |

Production of Toner Particle:

| | |
|---|---|
| resin dispersion liquid (resin particle solid content of | 400.0 parts |
| 25.0% by mass) | |
| colorant dispersion liquid (Metallic Compound A, content | 33.6 parts |
| of 11.0% by mass) | |
| mold release agent dispersion liquid | 30.0 parts |
| SANISOL B50 | 2.0 parts |

These were mixed and dispersed in a round stainless steel flask by the ULTRA-TURRAX T50. While these were stirred, the flask was heated to 48° C. by a heating oil bath. The flask was kept at 48° C., and the content was observed by an optical microscope. It was found that agglomerated particles having a size of approximately 6 μm were produced. The temperature of the heating oil bath was further raised, and the flask was kept at 50° C. for 1 hour. The content in the flask was observed by the optical microscope. It was found that agglomerated particles having a size of approximately 6.5 μm were produced. Subsequently, 3 parts of NEOGEN SC was put into the stainless steel flask, and the flask was sealed. Using magnetic seal, the flask was heated to 105° C. while stirring was continued. The flask was kept at 105° C. for 3 hours. After cooling, the reaction solution was filtered. The obtained product was sufficiently washed with ion exchange water, dried, and classified to obtain toner particles.

Further, hydrophobic silica fine powder was externally added to the toner particles in the same manner as in Production Example of Toner 1. Thereby, Toner 19 was obtained. Toner 19 was evaluated in the same manner as in Example 1, and the result of evaluation is shown in Table 3-2.

### Example 20

Toner 20 was obtained by performing the same operation as that in Production Example of Toner 1 except that copper phthalocyanine (C.I. Pigment Blue 15:3) was replaced by carbon black (trade name: Nipex 30, made by Evonik Industries AG). Toner 20 was evaluated in the same manner as in Example 1, and the result of evaluation is shown in Table 3-2.

### Example 21

Toner 21 was obtained by performing the same operation as that in Production Example of Toner 1 except that copper phthalocyanine (C.I. Pigment Blue 15:3) was replaced by C.I. Pigment Violet 19. Toner 21 was evaluated in the same manner as in Example 1, and the result of evaluation is shown in Table 3-2.

### Comparative Example 1

Toner 22 was obtained by performing the same operation as that in Production Example of Toner 1 except that no Metallic Compound A was added. Toner 22 was evaluated in the same manner as in Example 1, and the result of evaluation is shown in Table 3-2.

### Comparative Example 2

Toner 23 was obtained by performing the same operation as that in Production Example of Toner 1 except that Metallic Compound A was replaced by 1.6 parts of an aromatic dicarboxylic acid boron compound LR-147 (made by Japan Carlit Co., Ltd.). Toner 23 was evaluated in the same manner as in Example 1, and the result of evaluation is shown in Table 3-2.

### Comparative Example 3

Toner 24 was obtained by performing the same operation as that in Production Example of Toner 18 except that no Metallic Compound A was added. Toner 24 was evaluated in the same manner as in Example 1, and the result of evaluation is shown in Table 3-2.

### Comparative Example 4

Toner 25 was obtained by performing the same operation as that in Production Example of Toner 19 except that no Metallic Compound A was added. Toner 25 was evaluated in the same manner as in Example 1, and the result of evaluation is shown in Table 3-2.

### Comparative Example 5

Toner 26 was obtained by performing the same operation as that in Production Example of Toner 1 except that Metallic Compound A was replaced by 0.31 parts of an aromatic dicarboxylic acid aluminum compound BONTRONE-88 (made by ORIENT CHEMICAL INDUSTRIES CO., LTD.). Toner 26 was evaluated in the same manner as in Example 1, and the result of evaluation is shown in Table 3-2.

### Comparative Example 6

Metallic Compound R was synthesized by the following method.

Metallic Compound R was obtained by the same method as that in the case of Metallic Compound A except that the aromatic compound in Synthesis Example of Metallic Compound A (Step 2) was replaced by 9.19 g of 2-hydroxy-5-phenoxybenzoic acid represented by formula (16):

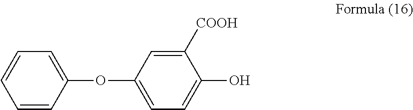 [SMILES: O=C(O)c1cc(Oc2ccccc2)ccc1O]

The content of aluminum in Metallic Compound R was determined by a fluorescent X-ray, and it was found to be 5.60% by mass.

A toner was produced by the same method as that in Example 1 except that Metallic Compound A was replaced by 0.32 parts of Metallic Compound R. Thus, Toner 27 was obtained. Toner 27 was evaluated in the same manner as in Example 1, and the result of evaluation is shown in Table 3-2.

### Comparative Example 7

Metallic Compound S was synthesized by the following method.

25.0 g of 2,3-dihydroxybenzoic acid was dissolved in 160 mL of methanol, and 40.00 g of potassium carbonate was added. The solution was heated to 65° C. 39.9 g of 1-bromopropane was dropped into the dissolution solution, and the reaction was made at 65° C. for 12 hours. The obtained reaction solution was cooled, and methanol was distilled away under reduced pressure to obtain a residue. The residue was dispersed in 3 L of water adjusted by hydrochloric acid to have a pH=2.0. Ethyl acetate was added, and an ethyl acetate phase was extracted.

Subsequently, the ethyl acetate phase was washed with water, and dried with magnesium sulfate. Ethyl acetate was distilled away under reduced pressure to obtain a precipitate. The precipitate was washed with hexane, and recrystallized with toluene/ethyl acetate to obtain 22.1 g of an aromatic compound represented by formula (17):

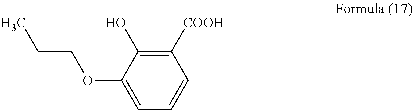

Next, Metallic Compound S was obtained by the same method as that in the case of Metallic Compound A except that the aromatic compound in Synthesis Example of Metallic Compound A (Step 2) was replaced by 7.83 g of the aromatic compound obtained above. The content of aluminum in Metallic Compound S was determined by a fluorescent X-ray. It was found to be 4.81% by mass.

A toner was produced by the same method as that in Example 1 except that Metallic Compound A was replaced with 0.42 parts of Metallic Compound S obtained. Thus, Toner 28 was obtained. The obtained toner was evaluated in the same manner as in Example 1, and the result of evaluation is shown in Table 3-2.

TABLE 2

| | Composition of resin produced | | | | | | | | | |
|---|---|---|---|---|---|---|---|---|---|---|
| | Polyester resin component | | | | | | | | | |
| | Polyester monomer component (mol %) | | | Vinyl resin component | | | | Physical properties of resin | | |
| | Polyhydric | | Content | Vinyl resin monomer | | | Content | produced | | |
| | alcohol | Polyvalent carboxylic | (% by | component (mol %) | | | (% by | Acid value | Molecular weight | |
| | component | acid component | mass) | Styrene | n-BA | Others | mass) | mgKOH/g | Mw | Mn |
| PES-1 | BPA(PO)50.0 | TPA/DMTPA4.9/45.1 | 100 | — | — | — | — | 2.3 | 13600 | 6000 |
| PES-2 | BPA(PO)49.9 | TPA/TMA35.5/13.9 | 100 | — | — | — | — | 12.1 | 17100 | 6300 |
| HB-1 | BPA(PO)49.9 | TPA/FMA43.4/6.7 | 70 | 81.9 | 17.1 | AA1.0 | 30 | 14.6 | 16500 | 10400 |

TABLE 3-1

| | | Toner outline | | | | | | | |
|---|---|---|---|---|---|---|---|---|---|
| | | | Formula of metallic compound existing in toner | | | | | | |
| | | | | Metal | | | | Content | Toner |
| | | | | reagent | Toner | | | of metal | particle |
| | | | | used for | production | Binder | | in toner | diameter |
| | | | Aromatic compound | reaction | method | resin | Colorant | μmol/g | μn |
| Example 1 | Toner 1 | A | 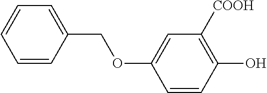 [SMILES: O=C(O)c1cc(OCc2ccccc2)ccc1O] | Aluminum sulfate | Kneading pulverization | PES-1 | C.I.Pig.Blue15:3 | 6.03 | 6.8 |
| Example 2 | Toner 2 | C | 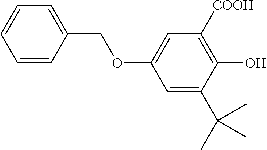 [SMILES: CC(C)(C)c1cc(OCc2ccccc2)cc(C(=O)O)c1O] | Aluminum sulfate | Kneading pulverization | PES-1 | C.I.Pig.Blue15:3 | 6.12 | 6.8 |
| Example 3 | Toner 3 | E | 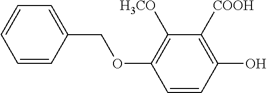 [SMILES: COc1c(OCc2ccccc2)ccc(O)c1C(=O)O] | Aluminum sulfate | Kneading pulverization | PES-1 | C.I.Pig.Blue15:3 | 6.02 | 7.1 |
| Example 4 | Toner 4 | H | 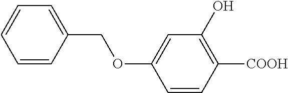 [SMILES: O=C(O)c1ccc(OCc2ccccc2)cc1O] | Aluminum sulfate | Kneading pulverization | PES-1 | C.I.Pig.Blue15:3 | 6.09 | 7.2 |
| Example 5 | Toner 5 | I | 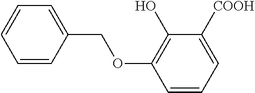 [SMILES: O=C(O)c1cccc(OCc2ccccc2)c1O] | Aluminum sulfate | Kneading pulverization | PES-1 | C.I.Pig.Blue15:3 | 6.02 | 6.9 |
| Example 6 | Toner 6 | D | 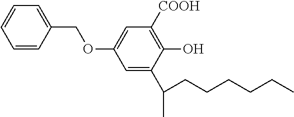 [SMILES: CCCCCCC(C)c1cc(OCc2ccccc2)cc(C(=O)O)c1O] | Aluminum sulfate | Kneading pulverization | PES-1 | C.I.Pig.Blue15:3 | 6.06 | 7.0 |
| Example 7 | Toner 7 | L | 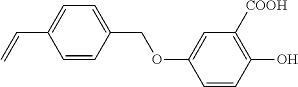 [SMILES: C=Cc1ccc(COc2ccc(O)c(C(=O)O)c2)cc1] | Aluminum sulfate | Kneading pulverization | PES-1 | C.I.Pig.Blue15:3 | 6.02 | 7.0 |
| Example 8 | Toner 8 | N | 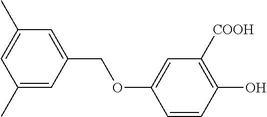 [SMILES: Cc1cc(C)cc(COc2ccc(O)c(C(=O)O)c2)c1] | Aluminum sulfate | Kneading pulverization | PES-1 | C.I.Pig.Blue15:3 | 6.01 | 6.8 |
| Example 9 | Toner 9 | O | 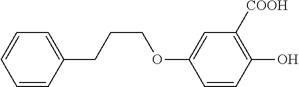 [SMILES: O=C(O)c1cc(OCCCc2ccccc2)ccc1O] | Aluminum sulfate | Kneading pulverization | PES-1 | C.I.Pig.Blue15:3 | 6.06 | 6.9 |
| Example 10 | Toner 10 | P | 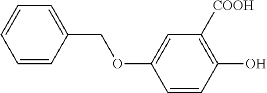 [SMILES: O=C(O)c1cc(OCc2ccccc2)ccc1O] | Zinc chloride | Kneading pulverization | PES-1 | C.I.Pig.Blue15:3 | 6.08 | 6.8 |
| Example 11 | Toner 11 | Q | 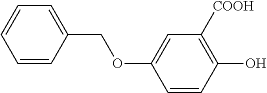 [SMILES: O=C(O)c1cc(OCc2ccccc2)ccc1O] | Chromium sulfate | Kneading pulverization | PES-1 | C.I.Pig.Blue15:3 | 6.07 | 6.9 |
| Example 12 | Toner 12 | A | 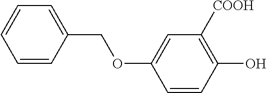 [SMILES: O=C(O)c1cc(OCc2ccccc2)ccc1O] | Aluminum sulfate | Kneading pulverization | PES-2 | C.I.Pig.Blue15:3 | 0.43 | 7.2 |
| Example 13 | Toner 13 | A | 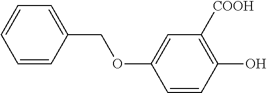 [SMILES: O=C(O)c1cc(OCc2ccccc2)ccc1O] | Aluminum sulfate | Kneading pulverization | PES-2 | C.I.Pig.Blue15:3 | 1.30 | 7.0 |
| Example 14 | Toner 14 | A | 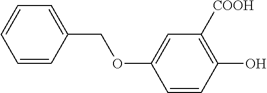 [SMILES: O=C(O)c1cc(OCc2ccccc2)ccc1O] | Aluminum sulfate | Kneading pulverization | PES-2 | C.I.Pig.Blue15:3 | 93.6 | 7.3 |
| Example 15 | Toner 15 | A | 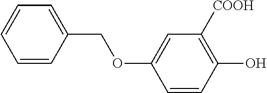 [SMILES: O=C(O)c1cc(OCc2ccccc2)ccc1O] | Aluminum sulfate | Kneading pulverization | PES-2 | C.I.Pig.Blue15:3 | 106.2 | 6.8 |
| Example 16 | Toner 16 | A | 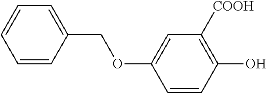 [SMILES: O=C(O)c1cc(OCc2ccccc2)ccc1O] | Aluminum sulfate | Kneading pulverization | HB-1 | C.I.Pig.Blue15:3 | 6.03 | 7.0 |
| Example 17 | Toner 17 | A | 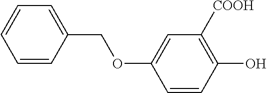 [SMILES: O=C(O)c1cc(OCc2ccccc2)ccc1O] | Aluminum sulfate | Suspension polymerization | — | C.I.Pig.Blue15:3 | 6.29 | 6.6 |
| Example 18 | Toner 18 | A | 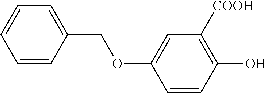 [SMILES: O=C(O)c1cc(OCc2ccccc2)ccc1O] | Aluminum sulfate | Dissolution suspension | PES-1 | C.I.Pig.Blue15:3 | 6.09 | 6.8 |
| Example 19 | Toner 19 | A | 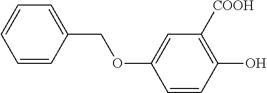 [SMILES: O=C(O)c1cc(OCc2ccccc2)ccc1O] | Aluminum sulfate | Emulsion agglomeration | — | C.I.Pig.Blue15:3 | 6.06 | 6.4 |
| Example 20 | Toner 20 | A | 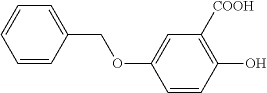 [SMILES: O=C(O)c1cc(OCc2ccccc2)ccc1O] | Aluminum sulfate | Kneading pulverization | PES-1 | CB | 6.03 | 7.0 |
| Example 21 | Toner 21 | A | 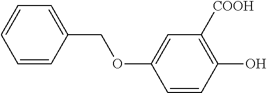 [SMILES: O=C(O)c1cc(OCc2ccccc2)ccc1O] | Aluminum sulfate | Kneading pulverization | PES-1 | C.I.Pig.Violet19 | 6.03 | 6.8 |
| Compara- tive Example 1 | Toner 22 | — | 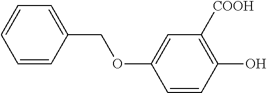 [SMILES: O=C(O)c1cc(OCc2ccccc2)ccc1O] | — | Kneading pulverization | PES-1 | C.I.Pig.Blue15:3 | — | 6.9 |
| Compara- tive Example 2 | Toner 23 | * Aromatic dicarboxylic acid boron compound LR-147 was used instead of organic metallic compound | | | Kneading pulverization | PES-1 | C.I.Pig.Blue15:3 | — | 7.0 |
| Compara- tive Example 3 | Toner 24 | — | — | — | Kneading pulverization | PES-1 | CB | — | 7.1 |
| Compara- tive Example 4 | Toner 25 | — | — | — | Kneading pulverization | PES-1 | C.I.Pig.Violet19 | — | 7.0 |
| Compara- tive Example 5 | Toner 26 | * Aromatic dicarboxylic acid aluminum compound E-88 was used instead of organic metallic compound | | | Kneading pulverization | PES-1 | C.I.Pig.Blue15:3 | 6.12 | 6.7 |
| Compara- tive Example 6 | Toner 27 | R | 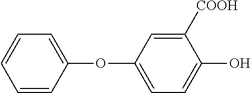 [SMILES: O=C(O)c1cc(Oc2ccccc2)ccc1O] | Aluminum sulfate | Kneading pulverization | PES-1 | C.I.Pig.Blue15:3 | 6.08 | 6.8 |
| Compara- tive Example 7 | Toner 28 | S | 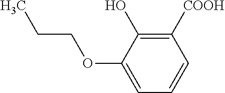 | Aluminum sulfate | Kneading pulverization | PES-1 | C.I.Pig.Blue15:3 | 6.05 | 7.0 |

TABLE 3-2

| | | Result of evaluation | | | | | | | | | | |
|---|---|---|---|---|---|---|---|---|---|---|---|---|
| | | | | | | | | Charging amount | | | | |
| | | | | | | | | stability before and | | | | |
| | | | | | | | | after toner is left | | | | |
| | | | | | | | | under high | | | | |
| | | | | | | Rise of toner | | temperature and | | | | |
| | | | | | | charging amount | | high humidity | | | | |
| | | Saturated | | Difference in | | on two-component | | (50° C./95% RH, | | | | |
| | | charging | | saturated | | developing sleeve | | three days) | | | | |
| | | amount at high | | charging | | at high temperature | | value of charging | | Evaluation | | |
| | | temperature | | amount | | and high humidity | | amount of toner | | of pigment | | |
| | | and | | between | | (H/H) | | shaken 200 times | | dispersibility | Reproducibility | |
| | | high humidity | | environments | | Ratio of | | Ratio of | | by visual | of halftone | |
| | | (H/H) | | (HH/ | | (Q5 | | (after leaving/ | | observation | | Evalu- |
| | | mC/ | Evaluation | LL) | Evaluation | min/Q2 | Evaluation | before | Evaluation | Evaluation | C*(70)/ | ation |
| | | kg | rank | ratio | rank | min) | rank | leaving) | rank | rank | L*(50) | rank |
| Example 1 | Toner 1 | −58.5 | A | 1.18 | A | 1.18 | A | 0.87 | A | A | 36.9/66.2 | A |
| Example 2 | Toner 2 | −64.1 | A | 1.15 | A | 1.10 | A | 0.89 | A | B | 36.6/67.0 | A |
| Example 3 | Toner 3 | −60.0 | A | 1.22 | A | 1.19 | A | 0.81 | B | A | 36.0/65.2 | A |
| Example 4 | Toner 4 | −56.3 | A | 1.27 | A | 1.18 | A | 0.86 | A | A | 35.9/65.7 | A |
| Example 5 | Toner 5 | −52.9 | A | 1.20 | A | 1.18 | A | 0.83 | B | A | 35.7/85.6 | A |
| Example 6 | Toner 6 | −49.7 | A | 1.23 | A | 1.16 | A | 0.86 | A | B | 34.7/65.2 | B |
| Example 7 | Toner 7 | −57.7 | A | 1.12 | A | 1.18 | A | 0.89 | A | A | 36.6/65.9 | A |
| Example 8 | Toner 8 | −53.0 | A | 1.25 | A | 1.18 | A | 0.80 | B | A | 35.4/85.7 | A |
| Example 9 | Toner 9 | −36.0 | B | 1.26 | A | 1.36 | B | 0.83 | B | A | 36.3/65.5 | A |
| Example 10 | Toner 10 | −42.6 | B | 1.28 | A | 1.37 | B | 0.82 | B | B | 36.5/63.2 | B |
| Example 11 | Toner 11 | −52.6 | A | 1.26 | A | 1.17 | A | 0.85 | A | A | 36.1/64.7 | B |
| Example 12 | Toner 12 | −20.8 | C | 1.40 | B | 1.38 | B | 0.80 | B | B | 35.1/63.4 | B |
| Example 13 | Toner 13 | −31.3 | B | 1.31 | B | 1.24 | B | 0.86 | A | B | 35.2/65.6 | A |
| Example 14 | Toner 14 | −78.2 | A | 1.22 | A | 1.17 | A | 0.88 | A | A | 35.5/66.8 | A |
| Example 15 | Toner 15 | −84.6 | A | 1.26 | A | 1.16 | A | 0.87 | A | A | 35.8/67.0 | A |
| Example 16 | Toner 16 | −60.5 | A | 1.16 | A | 1.17 | A | 0.81 | B | A | 36.6/67.2 | A |
| Example 17 | Toner 17 | −74.6 | A | 1.09 | A | 1.14 | A | 0.82 | B | A | 36.6/67.2 | A |
| Example 18 | Toner 18 | −44.4 | B | 1.27 | A | 1.33 | B | 0.82 | B | A | 32.1/61.5 | B |
| Example 19 | Toner 19 | −40.6 | B | 1.32 | B | 1.25 | B | 0.80 | B | B | 30.7/62.2 | B |
| Example 20 | Toner 20 | −48.0 | A | 1.34 | B | 1.18 | A | 0.83 | B | A | 1.09 | A |
| | | | | | | | | | | | (*1) | |
| Example 21 | Toner 21 | −51.9 | A | 1.13 | A | 1.19 | A | 0.84 | B | A | 33.5/63.0 | B |
| Comparative | Toner 22 | −11.6 | D | 2.40 | D | 2.30 | D | 0.73 | C | C | 31.2/61.0 | B |
| Example 1 | | | | | | | | | | | | |
| Comparative | Toner 23 | −14.4 | D | 1.93 | C | 1.88 | D | 0.80 | B | C | 29.7/60.3 | C |
| Example 2 | | | | | | | | | | | | |
| Comparative | Toner 24 | −4.3 | D | 1.73 | C | 1.65 | D | 0.76 | C | c | 1.30 | C |
| Example 3 | | | | | | | | | | | (*1) | |
| Comparative | Toner 25 | −14.1 | D | 2.11 | D | 2.21 | D | 0.72 | C | C | 31.0/58.5 | C |
| Example 4 | | | | | | | | | | | | |
| Comparative | Toner 26 | −47.3 | A | 1.40 | B | 1.35 | B | 0.67 | D | B | 35.3/64.0 | B |
| Example 5 | | | | | | | | | | | | |
| Comparative | Toner 27 | −33.7 | B | 1.52 | C | 1.62 | D | 0.81 | B | A | 35.5/67.0 | A |
| Example 6 | | | | | | | | | | | | |
| Comparative | Toner 28 | −19.6 | C | 2.09 | D | 1.70 | D | 0.64 | D | B | 32.1/60.8 | B |
| Example 7 | | | | | | | | | | | | |

In the table,
(*1) represents the ratio of (DO.4 − DO.3)/(DO.7) for evaluation of the black toner.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-196801, filed Sep. 9, 2011, which is hereby incorporated by reference herein in its entirety.

What is claimed is:

1. A toner comprising toner particles each comprising a metallic compound and a colorant, wherein
the metallic compound is a compound having a structure bonded to a metal in a site derived from —COOM¹ and/or —OH of a salicylic acid structural moiety or a salicylic acid derivative structural moiety of an aromatic compound represented by formula (1): 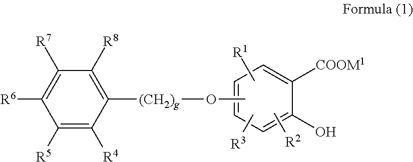
wherein R¹ to R³ each independently represent a hydrogen atom, a hydroxyl group, a carboxyl group, an alkyl group having not less than 1 and not more than 18 carbon atoms, or an alkoxy group having not less than 1 and not more than 18 carbon atoms;
R⁴ to R⁸ each independently represent a hydrogen atom, a vinyl group, a hydroxyl group, an alkyl group having not less than 1 and not more than 18 carbon atoms, or an alkoxy group having not less than 1 and not more than 18 carbon atoms;
g represents an integer of not less than 1 and not more than 3;
M¹ represents a hydrogen atom, an alkali metal, NH₄, or a mixture thereof.

2. The toner according to claim 1, wherein the metal contained in the metallic compound is a metal selected from the group consisting of Zn, Al, Si, B, Fe, Cr, and Zr.

3. The toner according to claim 1, wherein the metal contained in the metallic compound is one of Zn, Al, and Cr.

4. The toner according to claim 1, wherein the metal derived from the metallic compound contained in the toner exists in the range of not less than 1.0 μmol and not more than 100 μmol per g of the toner.
